(19) United States
(12) Patent Application Publication
(10) Pub. No.: US 2001/0056398 A1
(43) Pub. Date: Dec. 27, 2001

(54) Method and system for delivering foreign exchange risk management advisory solutions to a designated market

(75) Inventor: Lois R. Scheirer, Lexington, MA (US)

Correspondence Address: WEINGARTEN, SCHURGIN, GAGNEBIN, & HAYES, LLP, TEN POST OFFICE SQUARE, BOSTON, MA, 02109, US

(73) Assignee: e-Vantage International, Inc.

(21) Appl. No.: 09/834,003

(22) Filed: Apr. 12, 2001

Related U.S. Application Data
(60) Provisional application No. 60/197,249, filed on Apr. 14, 2000.

(51) Int. Cl. G06G 1/12; G06F 17/60

(52) U.S. Cl. 705/38

(57) ABSTRACT

Consistent with principles of the present invention, a method and system for delivering foreign exchange risk management advisory solutions to a designated marked is disclosed. For each user, the disclosed system generates an exposure model that is consistent with that user's risk management policy and a budget/pricing determination made in response to user information and external pricing information. The disclosed system may further operate to determine an appropriate measurement of risk and associated hedge alternative for a user, consistent with economic forecasts, and process a request for a hedge instrument from the user. Various hedge instruments may be analyzed and/or obtained through the disclosed system, including spot contracts, forward contracts, option contracts, and money market instruments. The disclosed system further provides extensive training, compliance and sales related features.

### CROSS REFERENCE TO RELATED APPLICATIONS

This application claims priority under 35 U.S.C. §119(e) to provisional patent application Ser. No. 60/197,249 filed Apr. 14, 2000.

### STATEMENT REGARDING FEDERALLY SPONSORED RESEARCH OR DEVELOPMENT

### N/A

### BACKGROUND OF THE INVENTION

This present invention generally relates to providing an end-to-end Internet based foreign exchange risk management advisory service, to a target corporate market, that is capable of educating, predicting needs, analyzing alternative solutions, matching product solutions to need, initiating solutions, and reporting and communicating the outcomes. In particular, the present invention relates to a Web site designed to provide these functions.

The World Wide Web (“WWW”) has rendered the Internet and other interactive online computer networks accessible to millions of companies all over the world. Concomitant with the emergence of this new communication medium, the opportunity for businesses to provide online interactive services for consulting, accounting systems, and knowledge services has motivated the development of new technologies. The demand for such online systems is estimated to be growing at a rapid rate, and such systems may be especially useful to small-to-mid-market enterprises (SMEs).

SMEs are increasingly using the Internet to expand worldwide, but also to face new competition in their traditional markets from global enterprises likewise using the Internet among other channels to expand across borders. Accordingly, the SME marketplace faces many new risks, perhaps the most challenging of which is currency risk. Currently, many SMEs deal with this risk by essentially ignoring it. For example, a United States based SME might export product pricing sales only in its “base” currency, the US dollar. This simple solution—transferring the currency risk to the business on the other end of the transaction, exposes one very important drawback to this currency risk management approach—the currency risk remains. It is merely transferred to the buyer. In general, in every set of cross border transactions, currency exposure presents itself in some form.

At the same time that cross-border business is rapidly expanding, the global currency markets remain volatile and difficult to predict. Additionally, new and complex US accounting standards, such as Financial Account Standards Board Number 133, which govern the use of instruments generally used to offset currency risk, require professional system capabilities. However, the ability to invest in systems is frequently limited in the SME sector, since financial resources are predominantly directed to product delivery. At the same time, it is not cost effective for SMEs to support the highly paid specialized staff with the expertise required to make effective foreign exchange risk management decisions.

The traditional sources of foreign exchange expertise and service to the SME market has been the regional banks. Such banks have in recent years gone through a sustained period of consolidation and automation. SMEs have traditionally looked to banks for education, advice on risk strategies, and market analysis. SMEs have paid for these services indirectly through transaction margins. Just at a time when the needs of SMEs in this area are growing, service is becoming unaffordable, since the small transaction sizes associated with SMEs limits the absolute profitability on trades relative to the service provider's other opportunities, even when a “retail” price is quoted. Furthermore, those banks still delivering personal service to SMEs generally delegate this responsibility to their least experienced and knowledgeable advisors.

While service delivery lags, efficiency of transaction delivery for most banks has been achieved through automated instrument pricing via software based “front ends” that are attached to trading systems. And generic market analysis, economic reports, and more recently educational materials such as generic explanations of instruments, automated calendars, and currency converters, are also available online. Consolidation in the banking industry and use of the Internet has largely eliminated personalized service delivery to the SME marketplace, and now product pricing via Internet automation is the preferred delivery mechanism.

For the reasons stated above, there is a need for a technology based, efficient, and personalized end-to-end currency risk management advisory system which delivers a full range of cost effective solutions directed to the SME marketplace. The system should be designed specifically to educate, predict, select, simplify, report and communicate global exposures to currency risk. The system should further facilitate the management of such risk in a way that is compliant with market and accounting practices. Such a system would advantageously simplify this complex area of international banking for SMEs, thereby enhancing their global opportunities by reducing the associated risk.

### BRIEF SUMMARY OF THE INVENTION

Consistent with principles of the present invention, a method and system for delivering foreign exchange risk management advisory solutions to a designated market is disclosed. For each user, the disclosed system generates an exposure model that is consistent with that user's risk management policy and a budget/pricing determination made in response to user information and external pricing information. The disclosed system may further operate to determine an appropriate hedge alternative for a user, consistent with economic forecasts, and process a request for a hedge instrument from the user. Various hedge instruments may be analyzed and/or obtained through the disclosed system, including spot contracts, forward contracts, option contracts, and money market instruments.

For example, under a given set of circumstances applicable to a particular user, the disclosed system operates to generate an exposure model by providing a user profile questionnaire in order to obtain user profile information. Based on such user profile information, the system forms and displays a user profile map illustrating in a graphical way the information provided by the user. The disclosed system further obtains an indication from the user that the customer profile map represents accurate user information. Prior to storing such user provided information, the system may also operate to obtain verification of user authorization levels, in order to verify that the user is authorized to provide certain types of user information.

As a further service, the disclosed system may operate to generate the exposure model for a given user by forming a policy template using policy information provided by the user. For example, the disclosed system may operate to input policy information through an interactive process for generating a policy via a predetermined set of questions. Generation of the exposure model by the disclosed system may further include formulating appropriate pricing strategies for inclusion in budgets that are associated with a specific user, and formulating a competitive position in relevant markets with regard to currency trends.

With regard to determining an appropriate hedge alternative, the disclosed system may operate to verify that a user is authorized to pursue a particular hedge alternative based on the contents of the previously received user profile. Furthermore, the disclosed system may operate to verify that a selected currency is permitted for a given user in connection with a hedge alternative, responsive to a user profile and policy. For example, the user profile formed by the system can define what specific users are authorized to use which specific hedge instruments in what amounts and currencies, and at what time of day. These parameters from the user profile may be used by a number of software “controls” that check transactions and other operations of a user during system operation, including during the step of determining an appropriate hedge instrument. Moreover, in order to prevent errors, the disclosed system operates to verify that an associated exchange rate or transaction amount is not corrupted during the communication process between the source of the rate and the local system, during determination of an appropriate hedge instrument.

A transaction may be initiated through the disclosed system that includes booking and confirming a requested hedge instrument. During such a transaction, in order to prevent errors, the disclosed system operates to verify consistency to the user's profile and policy, and to detect any transmission corruption. Reporting of such a transaction is further provided consistent with standard accounting practices appropriate for the specific user.

In an illustrative embodiment, the disclosed system provides a Web-site based application including a number of associated software processes. The software processes operate to support pre-selling of foreign exchange products to corporate clients. The disclosed system further operates to create an information base describing user community attributes. Moreover, the disclosed system educates, predicts needs, generates a user specific data set, and communicates benchmarked results to certain users through a “best practices” survey and associated, benchmarked results. The disclosed system additionally makes virtual sales calls for foreign exchange services to corporate clients in a target market, in a way that educates, predicts needs, matches products to needs across a full spectrum of product offerings, and communicates results, through inputting of a customer profile in connection with exposure mapping through a graphical representation of user information.

The server based processes of the disclosed system further operate to create a personalized foreign exchange policy that educates, predicts, simplifies, selects, communicates, and controls user specific policy requirements. A policy template and associated process, together with relevant online workshops and information files, may be employed in this regard, in combination with the above mentioned best practices survey with benchmarking.

The disclosed system further operates to measure exposure to currency risk in a way that educates, predicts, selects, simplifies, reports and communicates, customized, user specific global exposures to currency risk and management alternatives through a risk measurement model, and associated workshops and information files. A user of the disclosed system may use the disclosed system to mitigate exposure to currency risk in a way that educates, predicts, selects, simplifies, communicates, and reports the most cost effective risk management alternative to the user. In this regard, the disclosed system evaluates foreign exchange market conditions in a way that educates, focuses, analyzes, selects and communicates market information relative to user specified currency risk management decisions.

The disclosed system additionally includes a process for educating and training exposed companies on currency risk identification and management through increasingly complex personalized problem solutions utilizing current market conditions and system functionality. Another aspect of the disclosed system includes a process for initiating, controlling and reporting transactions consistent with generally accepted accounting standards that are used to offset and neutralize currency exposures for download into accounting systems using standard protocol.

The advantages of the disclosed system are many. In particular, the disclosed system integrates end-to-end personalized services that produce time and cost savings with all services at one Web site location. Further, it automates functions currently not automated and fosters a sense of community. It educates and simplifies the management process while making it more effective. It meets standards for financial reporting by country of operation. The minimalist presentation provided through the disclosed system, together with its controls, integrated current market data, compliance features, focusing attributes, and integrated educational content, ensures proper use of the system and proper risk management. Further, the disclosed “in-and-out” design enables users coming “in” to quickly focus on changing market conditions and changing exposures relative to benchmarks since a prior visit, obtain needed perspectives on changes and/or solutions, and then go “out” of the system to attend to other activities. With this approach, the disclosed system predicts what users need and delivers the solution in a concise, directed display in a manner that addresses both common errors in judgment and currency related calculations within the intended marketplace.

For banks in particular, the disclosed system enables cost-effective delivery of new dimensions of service that are compliant with banking best practices and complements existing technology. In this regard, the disclosed system may be employed by a bank to provide a front-end capability, or an interface to the bank's existing transaction automation platform or e-commerce platforms. Banks will be able to offer advice through the disclosed system that in turn generates transaction sales at any time or place. Banks will further be able to devise quick and effective strategies, assure consistent and accurate decisions, delegate opportunities, and efficiently link advisory services to transaction sales—content to commerce. Further, the system tracks usage and provides full reporting that includes predicting of needs and matches to appropriate marketing strategies. As a result, the disclosed system will change the way banks relate to their customers in this marketplace and create new revenue opportunities.

### BRIEF DESCRIPTION OF THE SEVERAL VIEWS OF THE DRAWING

The invention will be more fully understood by reference to the following detailed description of the invention in conjunction with the drawings, of which:

FIG. 1 illustrates a client-server computer network including hardware and software components through which the disclosed system may be embodied;

FIG. 2 illustrates an embodiment of the disclosed 5-step process for providing end-to-end real time currency risk management advisory solutions to a target market, and the automated services that support delivery of that process;

FIG. 3 illustrates, through the elemental components of an illustrative best practices survey, an exemplary methodology embodied in the disclosed system for connecting content to commerce, for utilizing technology to provide knowledge which supports changed behavior and results in expanded transaction and profit opportunities, for building community, and for creating proprietary content within an automated service delivery system;

FIG. 4 is a diagrammatic representation of an embodiment of the disclosed process for summarizing and displaying the user's exposure in increasing detail through an exposure map that is created simultaneously to the user completing the customer profile and that rewards the disclosure of exposure information by graphically presenting the company's full exposure;

FIG. 5 illustrates a plurality of inter-operating software components that may be used to quickly and effectively develop and maintain an understanding of currency market conditions that are relevant to predicting and managing risk exposures, through the integration of current and historical user specific data and personalized interpretative data;

FIG. 6 illustrates display objects which enable users to obtain analysis of the condition of the foreign exchange market through an “in-and-out” methodology which focuses on pertinent factors quickly and concisely, and which operates to relate the foreign exchange market to the user's current and historical risk positions in such a manner that foreign exchange transaction sales opportunities are nurtured while compliance criteria are applied;

FIG. 7 illustrates display objects presenting country economic analysis in a minimalist format that creates a focused user perspective on currency risk management in a short amount of time, and that integrate reporting of company exposures for benchmarking and compliance consistent with the disclosed in-and-out methodology;

FIG. 8 illustrates the disclosed process for providing personalized real-time learning experiences in currency risk management, utilizing Web site technology, through the application of sequential problem solving, with increasing complexity, associated with milestones in international business growth, and which enables a user to predict and communicate risk management solution needs, and to identify the related compliance characteristics for best practices, while also forming a basis for forming a virtual “community” among users of the system;

FIG. 9 illustrates the disclosed process operative to train, configure, report, and communicate with regard to a governing policy that directs and monitors all aspects of currency risk management for one or more users, and that is designed for the target market decision characteristics;

FIG. 10 illustrates the disclosed process operative to train, calculate, evaluate, predict, track, and communicate with regard to foreign currency pricing and budget decisions, using a plurality of sequential models designed for the target market's decision characteristics, and that creates an end-to-end real time user experience under applicable compliance standards;

FIG. 11 illustrates the disclosed process operative to train, calculate, evaluate, predict, report, and communicate economic exposure to currency risk, designed for the target market's decision characteristics;

FIG. 12 shows a calculation matrix illustrating the disclosed process for calculating one or more alternative price lists, under a range of strategies, and for performing multiple variance analysis as a basis for determining economic exposure;

FIG. 13 illustrates the disclosed process for integration of form and function to communicate complex analysis in a clear, precise, and minimalist way relative to evaluating competitive exposure designed for the target market's decision characteristics;

FIG. 14 illustrates the disclosed process for training, calculating, evaluating, predicting, reporting and communicating with regard to the development of price lists and budgets in foreign currency designed for the target market's decision characteristics;

FIG. 15 illustrates the disclosed calculations for conversion of price list(s) through the present three-step process;

FIG. 16 illustrates the disclosed process for training, calculating, evaluating, predicting, tracking, and communicating foreign currency risk measurement and mitigation strategies using a plurality of sequential models, designed for the target market's decision characteristics, that together and in sequence create an end-to-end real time experience under applicable compliance standards;

FIG. 17 illustrates calculations and procedures using a plurality of sequential models that are created to measure exposure to currency risk and to identify and measure the associated risk management strategies;

FIG. 18 illustrates a method for identifying a user's risk mitigation requirements based on a plurality of factors, and for predicting the exposure mitigation model to utilize in managing the risk;

FIG. 19 shows an illustrative appearance of a display for presenting, calculating, evaluating, predicting, and analyzing outcomes of strategies for the management of exposure designed for the target market decision characteristics;

FIG. 20 illustrates the functionality of a foreign currency transaction entry screen;

FIG. 21 illustrates the disclosed calculations that create the user's summary report of overall position relative to currency risk which is one embodiment of the present invention;

FIG. 22 illustrates the disclosed compliance process for management of currency risk;

FIG. 23 illustrates exemplary customer relationship management functions that may be embodied in the disclosed system, and that are designed to foster and predict transaction sales, build customer loyalty, and efficiently measure customer activities;

FIG. 24 illustrates an exemplary embodiment of the disclosed system in using an integrated process flow;

FIG. 25 illustrates features that may be accessed by a plurality of foreign exchange risk advisors or client users, that are communicably coupled to a server system in order to expertly select, apply, and report on the full range of end-to-end risk management solutions through a knowledge engine component, decision support technology component, and a transactional interface component.

### DETAILED DESCRIPTION OF THE INVENTION

The disclosure of provisional patent application Ser. No. 60/197,249 filed Apr. 14, 2000, is hereby incorporated by reference herein.

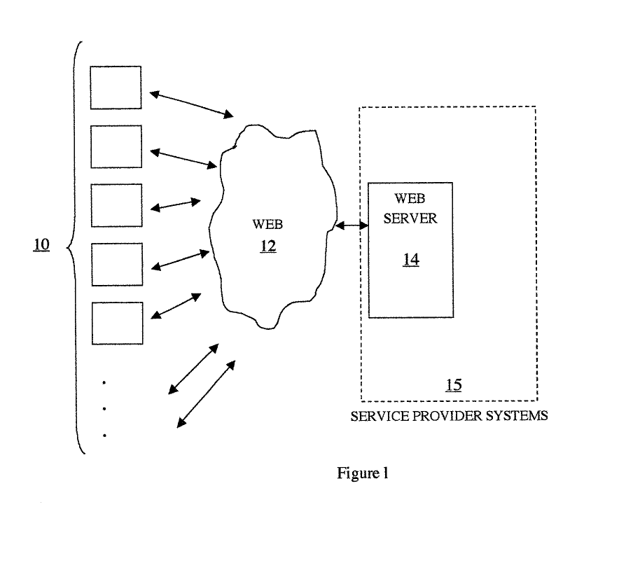

As shown in FIG. 1, a plurality of client systems 10 are communicably coupled via the World Wide Web (“Web”) 12 to a server system 14. The server system 14 is, for example, one or more computer systems operating within a number of service provider systems 15. During operation of the elements shown in FIG. 1, users of the client systems 10 employ client software, such as a browser computer program, to communicate with a Web site provided by Web server software executing on the server system 14.

For example, as shown in FIG. 1, client systems 10 effect transactions to the server system 14 using the Hypertext Transfer Protocol (HTTP), which is a known application protocol providing users access to various types of files (e.g. text, graphics, images, sound, video, etc.) using a standard page description language known as the Hypertext Markup Language (HTML). A Web page is a document that is accessible over the Web, and that is typically identified using a Uniform Resource Locator (URL). Accordingly, requests for Web pages through an HTML-compatible browser (e.g. Netscape Navigator or Microsoft Internet Explorer) executing on one of the client systems 10 generally involve specification of a requested Web page by that Web page's URL. The requesting one of the client systems 10 receives, in return, a document or other object formatted according to HTML. A collection of Web pages and/or other documents or programs supported on a Web server or servers, such as the Web server 14, is sometimes referred to as a Web site.

In a preferred embodiment, the server system 14 includes a Web site and an associated information database. Thus the server system 14 provides a Web-based application program accessible by the client systems 10 over the World Wide Web 12. As it is generally known, the client systems 10 typically include a suite of conventional Internet tools, including a Web browser, operable to access and obtain services from servers connected to the Web 12. Various known Internet protocols are used in connection with the services provided by servers within the Web server system 14. Thus, for example, browsing may be provided using the Hypertext Transfer Protocol (HTTP), which provides users of the client systems 10 access to multimedia files, including files written in the Hypertext Markup Language (HTML).

For purposes of illustration, a representative one of the client systems 10 may be a personal computer, notebook computer, Internet appliance or personal computing device (e.g. a PDA), that may, for example, be based on one or more x86-, PowerPC®, or RISC type processors. An illustrative client system may include an operating system such as Microsoft Windows or Microsoft Windows CE. As noted above, each client system may include a suite of Internet tools including a Web browser, such as Netscape Navigator or Microsoft Internet Explorer, that may have a Java Virtual Machine (JVM) and/or support for application plug-ins or helper applications.

Further for purposes of illustration, a representative Web server system 14 is based on an Intel i686 central processing unit (CPU), and includes an associated memory for storing programs executable on the CPU. The Web server system 14 further runs an appropriate operating system, such as the Linux operating system and the Apache Web server program. Various communication links may be used to connect to the Web server system 14, such as a Digital Subscriber line or T1 connection. In the illustrative embodiment in which the disclosed system is embodied as software executing in connection with a Web site, the following description and associated figures describe operation of the software associated with and accessed through such a Web site.

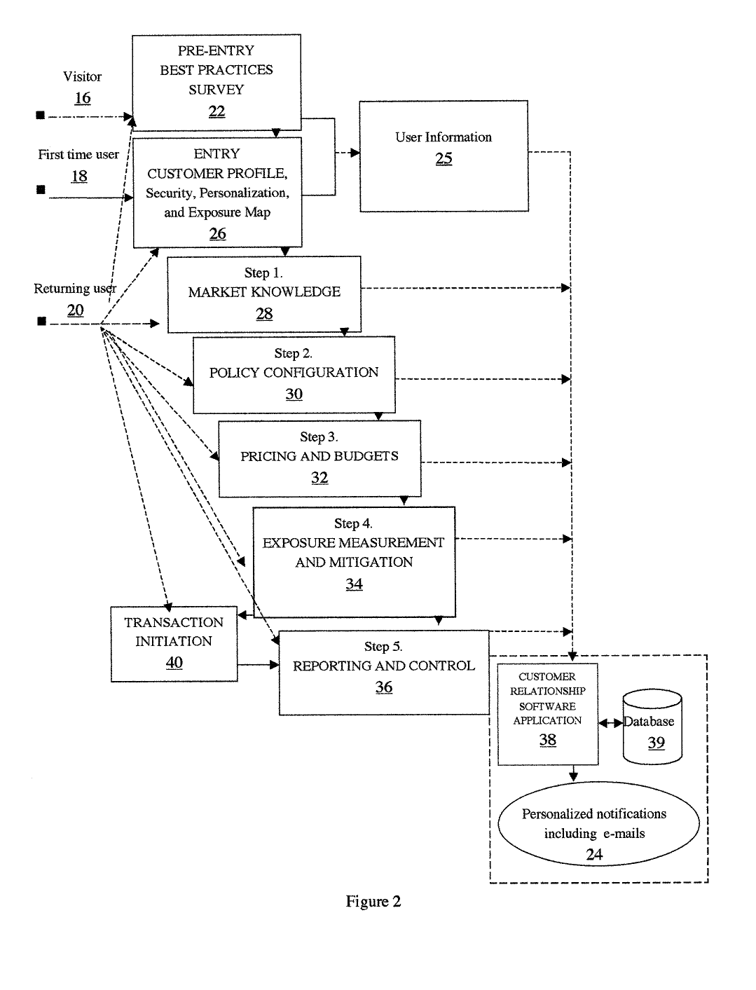

As shown in FIG. 2, a visitor 16 to the disclosed Web site may be provided a software component 22 with a sales promotion functionality for the system, shown for purposes of illustration as an on-line, best practices survey. The survey provided by the software component 22 may, for example, consist of a series of screens or Web pages including categorized inquiries. As used herein, the term “best practices” refers to preferred methods, operations processes and/or controls for achieving consistent and desired risk management results.

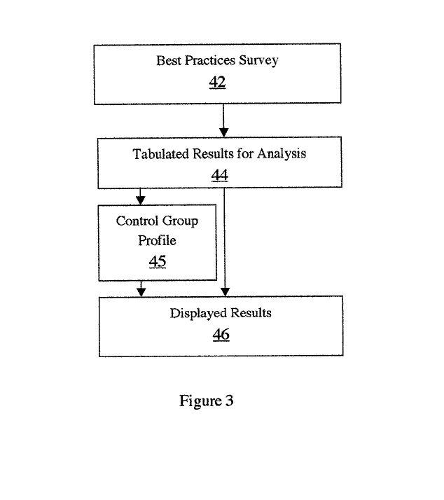

FIG. 3 shows an example of steps that perform the best practices survey provided by the software component 22 in FIG. 2. As shown in FIG. 3, an initial step of obtaining customer specific background data through an on-line best practices survey is performed at step 42. The customer specific background data obtained at step 42 may include company or individual registrant specific information, answers to questions directly related to visitor specific risk exposures such as measurements of risk and management strategies employed, and/or answers to risk mitigation implementation questions relating to such operations as trading, settlement and control activities.

Next, at step 44, the disclosed system tabulates results from the survey provided at step 42. The tabulation performed at step 44 organizes the survey results so that the information is categorized with respect to various methods of risk mitigation, and compared to baseline information. The baseline information may include or exclude the information received from any given user. The baseline information may be selected from in or outside of the registrant based on predetermined answers to select questions indicative of preferred risk management practices. For example, if a given user provides an answer to one of the questions provided during the best practices survey that matches a predetermined “best” answer to that particular question, then the disclosed system may operate to store one or more answers to other questions received from that given user as “baseline” information at step 45.

At step 46, the disclosed system displays the results of the tabulation performed at step 44. The results displayed at step 46 may show only the information provided by the current user, or the information provided by the current user as well as relevant baseline information. The display provided at step 46 may also include solicitations for use of the site to deliver relevant functionality, and offer opportunities for signing-up for access to the full capabilities of the site.

The best practices survey provided by the software component 22 of FIG. 2 is provided by the disclosed Web site for the purpose of motivating a site visitor to use other features of the Web site. For example, the software component 22 of the disclosed system could output information and/or questions designed to determine how the Web site could provide an advantageous service to the current user. The operation of the disclosed system through the software component 22 may further be designed to guide a user to one or more predetermined services provided by the Web site. In addition to the baseline information described above, the disclosed Web site may also generate a database consisting of information provided by various visitors to the site through the software component 22 over time for the purpose of determining customer needs with regard to prospective automated services or features that could be offered by the Web site. Since the information stored in such a database is specific to and known only to a particular instance of the disclosed Web site, it may be treated as a proprietary asset by a service provider/owner of the Web site.

Further in connection with the software component 22 of FIG. 2, the disclosed system may operate to allow a site visitor to register with the system by entering an email address and/or other information. In return for such registration, the disclosed system may provide data to the visitor that may be relevant to his or her needs, such as the results of analysis performed on all data collected through the best practices survey, and/or best practices information from some other source.

Information obtained through the on-line best practices survey provided by the software component 22 may further be used by a provider of the Web site to provide personalized notifications including e-mail 24, for example to be forwarded to specific customers by a customer relationship software application 38. Responses to such notifications may further support the development of marketing information by a service provider.

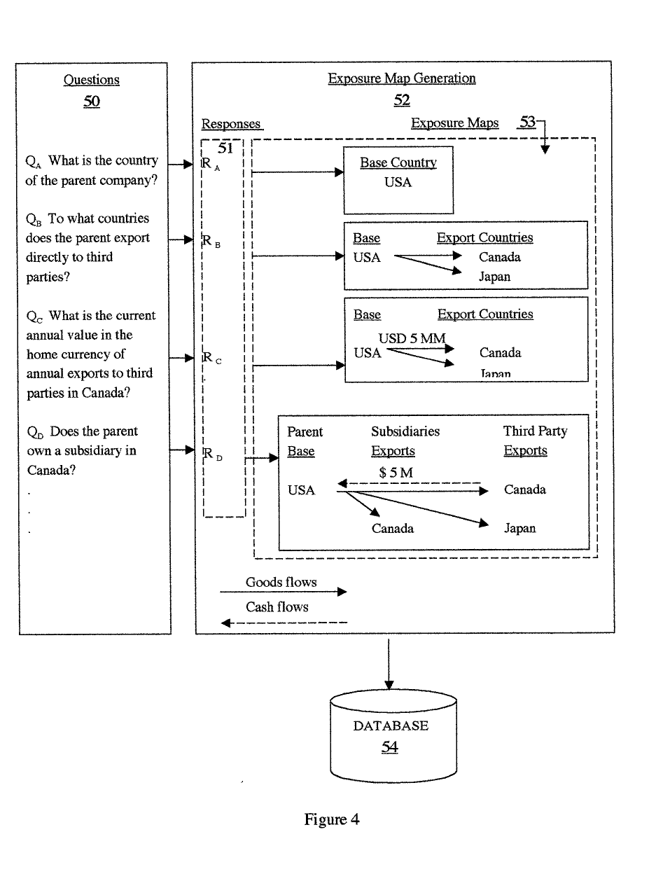

The disclosed system further enables a first time user 18 to skip the best practices survey generated by the software component 22, and start directly by accessing the software component 26, through which the first time user 18 completes an on-line customer profile provided by the disclosed system. Further with regard to the software component 26, based on the customer profile information obtained therein, the disclosed system displays an exposure map, for example through a graphical user interface (GUI). An example of how the disclosed system generates exposure maps is diagrammatically represented in FIG. 4.

As shown in FIG. 4, as each of the questions 50 are answered, the relevant exposure to foreign exchange rates is presented in one of the exposure maps 53. In particular, as a first question Q_{A} is answered with a first response R_{A}, a corresponding one of the exposure maps 53 is presented to the user. In the case where the first question is an inquiry as to the country of the parent company of the user, and the response is USA, then the exposure map generated would illustrate that the base country of the user is the USA. Each subsequent exposure map would add visual components reflecting subsequent answers. For example, if the next question asked what countries the parent company exported to, and the corresponding answer indicated Canada and Japan, then the disclosed system would generate an exposure map showing both that the base country of the parent is the USA, and that goods from the parent company flow to Canada and Japan. If a subsequent question asked what the annual value of the exports of the parent company to one of the countries to which the parent company exported to, then the corresponding exposure map would visually illustrate the value provided in the response. For example, if the answer indicated that the annual value of the parent company's exports to Canada were $5,000,000.00, then the disclosed system would display the $5,000,000.00 value in visual association with the export of goods to Canada in the resulting exposure map. This process continues until all of the questions 50 are answered, thus progressively building a graphical representation of all the responses provided to each of the questions 50.

The information obtained through the responses to the questions 50 may further be stored in a database 54 for subsequent personalization of features or services of the disclosed system, matching to services and for other analytical purposes. The exposure maps 53 provided in the process illustrated in FIG. 4 are designed to motivate the user to provide data into the customer profile through the software component 26 of FIG. 2, and the data presented in the exposure maps 53 is provided in a way that predicts the display format and features of various components provided by the disclosed system. The information provided by users through the customer profile also predicts user needs in other banking areas that may be serviced by the service provider. Accordingly, the customer profile information may also be shared with various other departments within the service provider, outside the foreign exchange area, such as those related to banking and/or borrowing services, thus potentially identifying and opening up sales opportunities across a number of business lines within the service provider.

With respect to a returning user 20 as shown in FIG. 2, a variety of entry points to the disclosed system are provided. For example, the entry of the returning user 20 to the disclosed system at any point is controlled by the contents of the user's security profile, as entered at step 26. The security profile of the user may limit entry and access to the disclosed system based on multiple user provided variables, including name, function, location, unit, time, currency, instrument, and other alternatives. The authorization information stored in a user profile may reflect authorization levels for a user provided by the user's organization, and/or authorization levels provided by the service provider In this way, the user's organization can control which persons are authorized to perform which actions through the system, and the service provider can control how the system provides information and/or services to each individual user or the system.

The returning user 20 may select from a number of alternative entry points or interfaces of the disclosed system, including interfaces to software components for obtaining market knowledge 28, configuring a policy 30 governing the activities of a user or of user's operating on behalf of a business , pricing a sale(s) in foreign currency 32, selecting a hedge instrument 34, and reporting on exposed positions 36. Individually and collectively the five components 28, 30, 32, 34 and 36 provide a powerful and flexible platform which supports an end-to-end, real-time, Internet-based risk management advisory capability. In the illustrative embodiment, the five software components 28, 30, 32, 34 and 36 are implemented using inter-operating, application layer software components associated with a Web site.

Through the five software components 28, 30, 32, 34 and 36, the disclosed system integrates complete personalized services and solutions that provide significant cost, time and information advantages by having complex specialized needs met at once place. Services provided by the disclosed system before and after transactions are designed to support the user's increasing needs for risk management resulting from exposures created by international trade and investment abroad.

The returning user 20 in FIG. 2 may be based in any country. As a consequence, any currency can be defined as the base currency for a given user. For illustrative purposes, the returning user 20 will be considered to be based in the United States, with a corresponding base currency of the United States (US) dollar. The returning user 20 may access the site, for example, in order to respond to a request from a prospective customer in Japan for a price quote on a product in Japanese yen (the ISO symbol of which is JPY) rather than a price quote in the company's customary pricing currency, for example the US Dollar (USD). The disclosed system may be used to break down the determination as to whether to provide the requested price quote into the following inquiries: (i) if the company quotes the price in US dollars, what is the likelihood that it might loose the sale to a competitor based on currency factors? (ii) what is the degree of currency risk associated with pricing in Japanese yen? (iii) if the company quotes the price in Japanese yen, how will the foreign currency price be derived? (iv) how will margins be protected against currency fluctuations until orders are placed and payment is received? and (v) how will the associated transactions be booked in the accounting system and controlled? The disclosed system moves step-by-step through this entire process, providing the necessary decision support technology and knowledge base for users to reach effective decisions and access the specific technology and tools that support implementation under best practice standards. Those skilled in the art will recognize that this example is provided for purposes of describing the operation of an embodiment of the disclosed system under one simple set of circumstances. Accordingly, it will be understood that the disclosed system is not limited in application to this particular problem, but may be generally applied to a variety of problems of varying complexity in this area.

In the case where the returning user 20 in FIG. 2 is a user making the above described decision regarding pricing a sale in Japanese yen, he or she may begin traversing the disclosed Web site by selecting the market knowledge component 28 shown in FIG. 2 as an entry point. As further described below, the market knowledge software component 28 may be used for obtaining relevant market knowledge as it relates to a returning user's personalized characteristics.

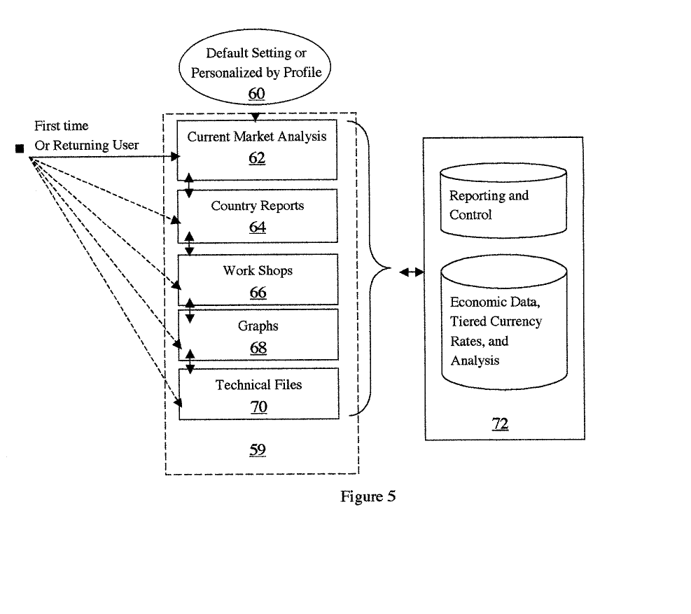

The process for obtaining relevant market knowledge performed by the software component 28 shown in FIG. 2 is further illustrated in FIG. 5. As shown in FIG. 5, a cluster of software components 59 is provided by the disclosed system to the user in order to provide knowledge of the currency exchange market consistent with input information including the user's profile 60. In the absence of a personalized profile for a given user, the input information 60 may consist of some number of default settings.

The user may select a current market analysis component 62 provided by the disclosed system. The current market analysis component 62 may display rates in table or graph format. Such displays may show currency forecasts, for example, for the yen's outlook, as well as information relative to the current pricing of a full range of risk mitigation instruments. The rates provided through these displays are tiered by the service provider, based on the identity of the user. In this way, the service provider can provide pricing that is specific to sets of customers, such as a first set of prices to tier 1 customers, a second set of prices to tier 2 customers, and so on. Because the site provides end to end support, in that a user can go from gathering background information all the way to completing a transaction, the disclosed system enables a service provider to present a single pricing structure to a given user throughout the entire process. This consistency of pricing, integrated with the end to end service available through the disclosed system, eliminates the user's need to go to another site to view market rates. Moreover, the prices provided to a given user may be kept constant across multiple visits by the user to the system, assuming that the user's status within the tiered pricing structure of the service provider remains constant. The specific pricing tier that a given user or company belongs to may be based, for example, on multiple factors including credit ranking, transaction volume, type of product, or average transaction size. If the user is unfamiliar with the relevant market, multiple features including workshops 66 can be personalized to this decision, and technical files 70 for quick reference are available for training. Hyperlinks and/or pull down menus describing technical terms are also included to provide immediately definitions, in order to support certainty of knowledge on the part of the user, thus acting as compliance features of the disclosed system.

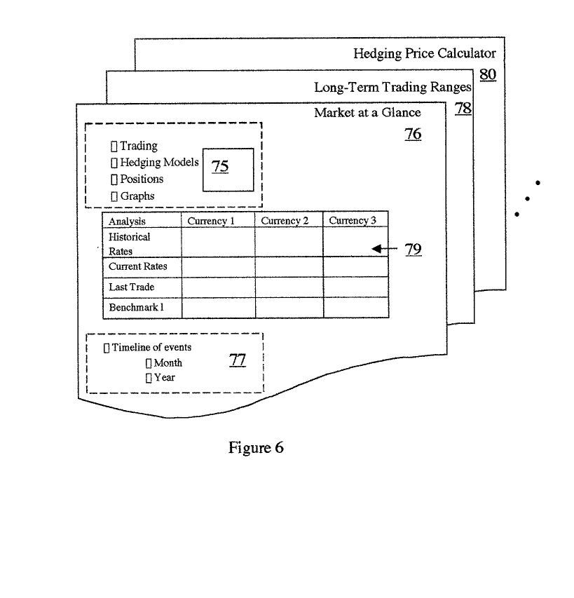

In FIG. 6 the range of offerings that may be provided through a user interface generated by the market analysis component 62 are further described. As shown in FIG. 6, three aspects of market analysis may be graphically displayed to the user. First, a market at a glance display object 76 may be selected that includes a rate analysis table 79. As shown in FIG. 6, the rate analysis table 79 displays historic, current and future rate analysis into which the returning user's personalized position data are integrated, or personalized benchmarks relative to decision-making support processes provided in other system modules.

Further in FIG. 6, a number of links 75 to support sales functionality are provided. For example, the links 75 may include hyperlinks to trading functionality, models, position displays, and graphing tools. Accordingly, if a user sees a rate they like in the rate analysis table 79, they can take appropriate steps to effect a transaction based on that rate through the links 75. The links 75 are designed to promote sales by the service provider.

Also in the display object 76 is shown a time line interface 77, through which the parameters of a time line representation of one or more rates may be indicated. The resulting time line representation would display forward and backward graphing of one or more rates over time, for example in a pop-up window that does not completely obscure the current display.

A long-term trading ranges display object 78 may also be selected by the user. The long-term trading ranges display object 78 provides, for example, forecasted trading ranges and volatility factors against personalized benchmarks. In addition, and also as shown in FIG. 6, a hedging price calculator display object 80 may be selected by the user in order to access various algorithms within the disclosed system for user-personalized comparison of risk mitigation strategies and instruments. The information and calculations associated with the display object 80 are integrated into the processes of software components 30, 32, and 34 of FIG. 2.

Now again with reference to FIG. 5, in connection with the user's illustrative access to the interfaces provided by the current market analysis software component 62, the disclosed system may present tiered exchange rates and market trends showing values for the Japanese yen against those for the US dollar. Such a display, for example, enables a quick perspective on the relevant data. Such a quick perspective supports an “in-and-out” use methodology, which enables a user to come “in” to the system, access updated market and position information quickly, solve his or her immediate problem, and then go “out” with the appropriate solution, without needing to visit the system multiple times, or traverse the system in multiple ways. In this regard, and as described in connection with the current market analysis component 62 of FIG. 5, the disclosed system educates the user by providing correct and focused analysis on pertinent market related data that are integrated directly with the user's current and historic positions using pre-selected benchmarks determined during the entry process as part of the customer profile acquisition performed by the component 26. Further, benchmarking for a particular user can be set at any time by the user in order to have multiple variables against which to evaluate market movements. As a result of these processes within the disclosed system, a returning user can quickly gauge relevant market conditions in a personalized context. In another aspect of the disclosed system, displays formatted for reporting and e-mailing are designed for easy communication such as to clients or reporting in meetings that demand presentation of market analysis.

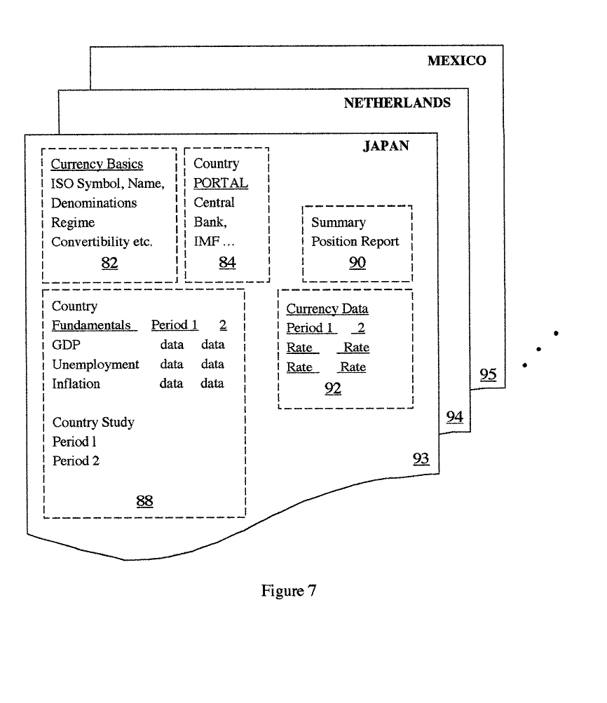

Another of the software components 59 of the disclosed system shown in FIG. 5 that may be employed by a user to obtain information regarding the trend of the Japanese yen is the country reports component 64. FIG. 7 shows illustrative display objects provided by the disclosed system through the country reports component 64 of FIG. 5. As shown in FIG. 7, the country reports component may display a number of country-specific display objects. For example, the display object 93 is associated with Japan, and includes basic information 82 on the currency such as its International Standards Organization (ISO) symbol, currency regime, currency convertibility, country fundamentals 88 including the country's flag, economic statistics and reports including graphs. The display object 93 is further shown including currency data 92 sorted in way that reflects the current user's interests. The display object 93 further includes a portal section 84 that provides links to key country resources such as business newspapers, stock exchanges, data centers, and central banks. To provide the user with a quick focus on relevant information, and in support of the “in-and-out” methodology on which the disclosed system is based, a summary position report 90 of total exposure and limits is further provided with respect to multiple risk categories. The information provided through the summary position report 90 is, for example, uploaded from the reporting and control component 36 shown in FIG. 2.

Further as shown in FIG. 7, information relating to a number of countries relevant to the user may be arranged in a stack of selectable display objects. For example, information display object 93 regarding Japan is shown in a front object, with information display object 94 regarding the Netherlands and information display object 95 regarding Mexico arranged underneath. As in a browser graphical user interface, a user may select the specific information display object desired by moving the mouse over the desired object and clicking on that object.

Yet another of the software components 59 in FIG. 5 that may be used to determine market risks is the graphs interface component 68. The graphs interface component 68 provides a user with graphs that are interpretative and personalized to ensure an accurate understanding of currency trends. Any currency pair can be selected for a comparative display using the graphs interface component, with multiple pairs selected against different axis for selected timeframes. Further percentage ranges can be specified to assure visual presentations that are consistent with underlying movements. Historical data is augmented by forecasts and or hedge instrument prices over the same time horizon. The graphs interface component 68 may provide graphs interpreting, for example, such factors as percentage movements over specified periods, and whether such trends are favorable or not relative to the user's personalized profile. The graphs provided through the graphs interface component 68 may further depict such personalized data as hedge prices and currency forecasts or personalized benchmarks such as annual budget rates. The graphing capability also supports the “in-and-out” methodology by integrating into the graphically represented data inputs from various sources including the reporting and control component 36 shown in FIG. 5.

Another software component within the software components 59 shown in FIG. 5 provides access to a set of technical files 70 for quick user reference on wide ranging market related topics. The technical files 70 may be accessed through multiple formats, including question and answer format, checklists, and/or tables. The topics covered by these technical files may include information related to the currency markets, currency risk management, or related trade banking services. Examples of such topics include: explanations of the Euro; historic annual trading ranges and volatility by currency and in groups of currencies; currency regimes; currency timelines; explanations of government intervention process; exposure definitions and comparisons; hedging instrument definitions; hedging strategy summaries; accounting treatments; letter of credit or documentary collections processes; trade finance basics; or checklists for related activities. This feature complements the workshops component 66 in FIG. 5, which provides in-depth learning experiences by allowing the user to quickly research any given topic. It is intended that the topic selections respond to user requests and that this is one aspect for creating community among users.

Yet another software component within the software components 59 shown in FIG. 5 is a workshops interface component 66, that provides automated tools to educate users on all related topics such as. The topics covered through the workshops interface component 66 include, for example, the fundamentals of the currency markets, and provide background knowledge to users based on their personalized decision-making requirements. These on-line workshops are personalized via feeds from a database 72 with user specific data compiled by the software component 26 shown in FIG. 2, as well as transaction and position history compiled by the reporting and compliance component 36 shown in FIG. 2. The on-line workshops may further be customized based on uploaded external market data including exchange rates, instrument pricing algorithms, and economic forecasts, for example.

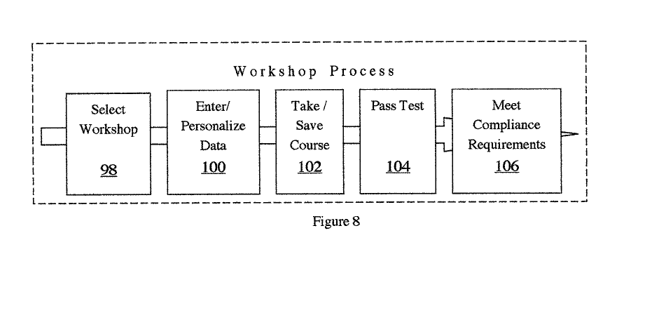

In FIG. 8, a process flow of an illustrative embodiment of the workshops software component 66 in FIG. 5 is depicted. Upon selecting the workshops component 66, the user may select and a specific online workshop in step 98, and then select personalized data in step 100 that can be input or uploaded. The personalize data is used by the disclosed system to customize the course content and delivery to the user's specific profile. Once the online workshop is completed in step 102, and an online test passed at step 104, the disclosed system records the fact that related compliance requirements have been met in a database at step 106 By passing a particular online test provided by the disclosed system, specific related compliance requirements may thus be met, thereby enabling a user to perform certain actions within the disclosed system which would otherwise be prevented until the user has demonstrated a base level understanding of the related concepts. In one embodiment, service providers 14 may disable certain compliance features after electronically signing a provided disclaimer within the compliance control software, depending on the banking regulations within the country of operation. Such compliance monitoring may be provided within control software that ensures compliance requirements have been met by each specific user prior to permitting that user to perform a specific related action, irrespective of authorities otherwise applied. In other words, even if a user has authority to perform an action from his or her company, the service provider can block access to that activity if any service provider established compliance standards have not been met by that user.

The workshop provided by the process shown in FIG. 8 may, for example, involve sequential problem solving with increasing complexity of decision making illustrative of decisions associated with major milestones in the international growth patterns typical of the target market to which the user belongs. To personalize workshops, the returning user 20 in FIG. 2 enters or uploads decision specific data. In the example of a user that has indicted a Japanese yen export, the user provided, decision specific data might include the following: “export” as the transaction or event under evaluation, Japanese yen as the foreign currency, US Dollars as the base currency, and $100,000 as the transaction value, with credit extension in the terms of trade of 90 days open account, with start date of today's calendar date and close date calculated in 90 days using an international holidays calendar. The disclosed system may then integrate tiered current market rates and use program code executing on the Web site to teach problem solutions through the online course. The personalization and use of Web site technology within the disclosed online workshops creates compliance features supporting “know your customer” requirements within the banking industry. In this way, the disclosed system uses technology to teach. By including interactive tests in step 90 of FIG. 8, the disclosed system ensures that tests must be passed for a user to be authorized by the disclosed system to access features such as those related to transaction entry, booking and policy development. Finally, the data from any workshop can be saved by the system for future reference with the option to refresh data. The system maintains an audit log of workshop tests scores among other compliance requirements related to each user.

Following completion of one or more of system components provided through the interfaces 59 of FIG. 5 in connection with the market knowledge component 28 of FIG. 2, the returning user 20 has obtained an understanding of the market relevant to the specific user's needs. For example, the returning user may have obtained an understanding of the currency risk associated with a potential Japanese yen export transaction, and alternative hedging strategies and related instrument prices in current market terms. If the returning user 20 remains uncertain about whether to provide a price quote in Japanese yen, they may elect to traverse the disclosed system, next selecting policy configuration component 30 in FIG. 2 to obtain further information.

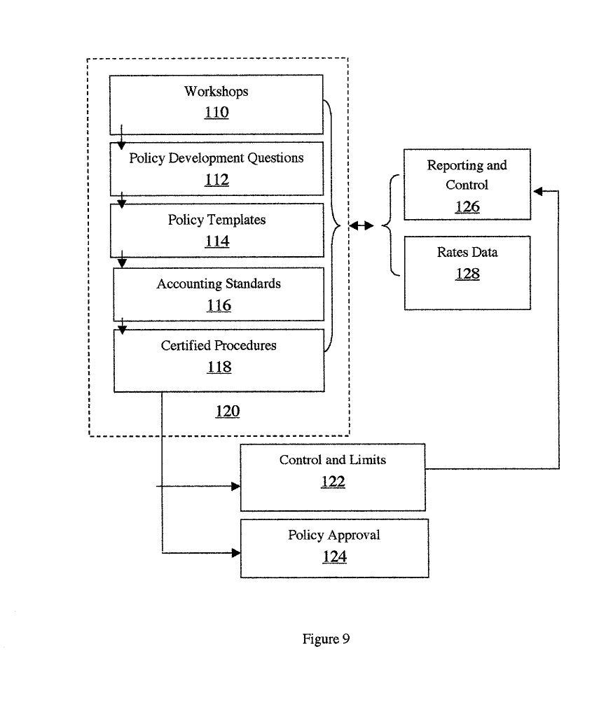

With respect to the returning user 20 in FIG. 2, a variety of entry points for the policy configuration software component 30 shown in FIG. 2 are available. For example, FIG. 9 illustrates software components 120 within the software component 30 in FIG. 2, that are available to a user. During operation of the disclosed system, the returning user 20 may, for example, initially select online workshops 110, in order to gain background information. The user then progresses to filling out an online policy development questionnaire provided by software component 112, moving progressively through a number of steps required in order to answer the questionnaire. For example, the questionnaire may be designed to guide the user through a number of activities which may take place on or off-line, beginning with such activities as gathering required background company specific data, obtaining senior management buy in, reviewing stockholder objectives, developing the program objectives, assigning responsibilities, identifying and measuring exposure accurately, evaluating cash flow exposures, identifying accounting and reporting standards, setting limits and a reporting and review process, assessing system needs, and finally presenting to the board of directors for any necessary sign off. The information obtained by the disclosed system through the policy development questions provided by the policy development software component 112 may be used by the system to upload data into a number of predetermined policy templates through software component 114. The policy templates loaded by the software component 114 include an overview of the user's foreign currency risk policy including its scope, overall approach to risk management, and authority. Other fields within these templates may include the various categories of currency risk the end user selects for certain defined purposes, measured in financial terms, with limits established by the user. The definitions of exposure stored within the policy templates may include for example the company's market and credit risks associated with the management of foreign exchange, such as net open positions by currency and in aggregate, its gap positions, counterparty risk, and country risk positions. Another group of policy templates formed by the software component 114 may include operations and trader conduct standards, operating procedures, exception reports and limits summaries by categories of risk. Finally, the software component 116 applies accounting standards 116 to the completed policy templates in step 116. The accounting standards applied by the software component 116 are country specific for financial reporting purposes. For example, in the United States, reporting on derivative instruments is governed by Financial Accounting Standards Board (FASB) #133. In this regard, designations of types of exposures and types of hedges are selected and the appropriate mark-to-market applied. Underlying transactions linked to the hedges are properly identified and accounting entries determined. Additionally, when the user's company has international operations, FASB 52 governs the translation of financial statements for consolidation in the parent. The software component 116 applies these standards to the policy templates, and generates accounting entries formatted for downloading into the company's standard accounting system.

The software component 118 applies certified site procedures, provided by the service provider on the site, are downloaded into the operations section of the policy templates to provide operating procedures reflecting best practices, as determined by the disclosed system. Thus the software component 118 operates to assure proper understanding of site capabilities, and use of the site, as one aspect of the compliance functionality of the disclosed system.

Further with reference to FIG. 9, a software component 122 establishes controls and limits for the policy templates. With reference to the above described determination regarding the risk of providing a price quote in Japanese yen for a company having a base currency of U.S. dollars, these controls and limits may relate to limits for: a) net open exposure to Japanese yen in the form of accounts receivables; b) the aggregate base currency (US dollar) equivalent net open exposure for all foreign currency accounts receivables of US $1 million; and c) the duration of exposure within 90 days. These limits are integrated into various control components and procedures that control the users actions and options throughout the disclosed site.

The software component features shown in FIG. 9 operate to address the needs of the target market for which the disclosed system is designed, in terms of handling the general pattern of exposure. Limits and controls, with mark-to-market using value-at-risk (VAR) methodology and variance reporting established via the generated policy templates, get uploaded to other site models via the control and limits software component 124. Governing the compliance process integrated throughout the site are limits uploaded into the policy templates. These limits require regular revaluation or marking-to-market based on value at risk methodology, as may be performed by a further software component 122. Additionally, the best practices survey provided by the disclosed system is based on the control features of the disclosed system, as exhibited in the policy templates. This brings high level controls and functionality to users who today generally have very limited compliance in their currency risk management process because of systems limitations and know how.

Following completion of the user's policy templates, any required approval of the policy templates is obtained by the software component 124. Such a third party may, for example, consist of the company's board of directors. A range of solutions for bypassing the required policy process may vary from a disclaimer requiring sign off by any returning user when the policy cycle is not completed, to require training, and/or to denying access to selected system capabilities such as transaction entry. The features of the disclosed system relating to foreign currency risk policy development give the service provider an effective and efficient methodology for delivering a high value service to end-users, creating broadened service opportunities that will result in more satisfied and educated customers, and result in higher transaction volumes for the service provider. For the end-user, these features deliver best practices standards at a low cost and high level of expertise.

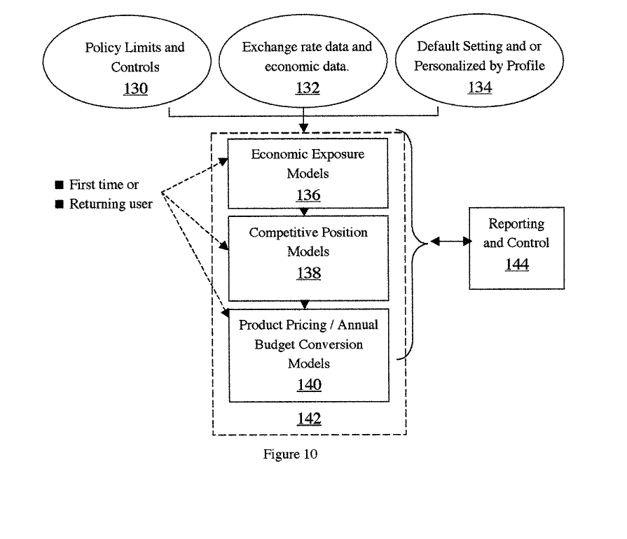

The returning user 20 may then further transverse the disclosed Web site, for example selecting pricing and budgets component 32 as shown in FIG. 2. The pricing and budgets component 32 provides decision support models that create a powerful progressive process for analyzing the pricing and budget decisions characteristic of the market segment for which the disclosed system is designed. Use of the software component 32 is governed by controls and limits established in through the software component 122 of the policy configuration component 30, as shown in FIG. 2. FIG. 10 further describes the process involved in creating foreign currency price lists and budgets during through operation of software component 32 as shown in FIG. 2.

FIG. 10 shows a number of software components 142 that provide service models to the first time or returning user. The service models provided by the software components 142 provide decision-making support around the conversion of prices to foreign currency and subsequent setting of foreign currency budgets. Input data is accumulated or uploaded prior to operation of the software components 142. Such input data includes tiered real time exchange rates and economic data 132. The data 132 may, for example, include such data as exchange rates and rate forecasts. These exchange rate forecasts may be adjusted by either a default setting or a personalized profile 134. The exchange rate forecasts may further be controlled by policy limits and controls 130. The complete, resulting initial data is fed into the software components 132, and forms the basis for the disclosed system to calculate pricing and perform types of analysis most relevant to a user's decision making process. In this regard, the disclosed system directs the user through a series of question groups designed to obtain the user specific data necessary to populate corresponding analysis model(s).

The software components 142 include, for purposes of illustration, software component 136, which operates to generate models for determining economic exposure 136. Software component 138, which operates to generate analysis models for evaluating competitive position, and software component 140, which operates to generate a product pricing/budget setting model in foreign currency.

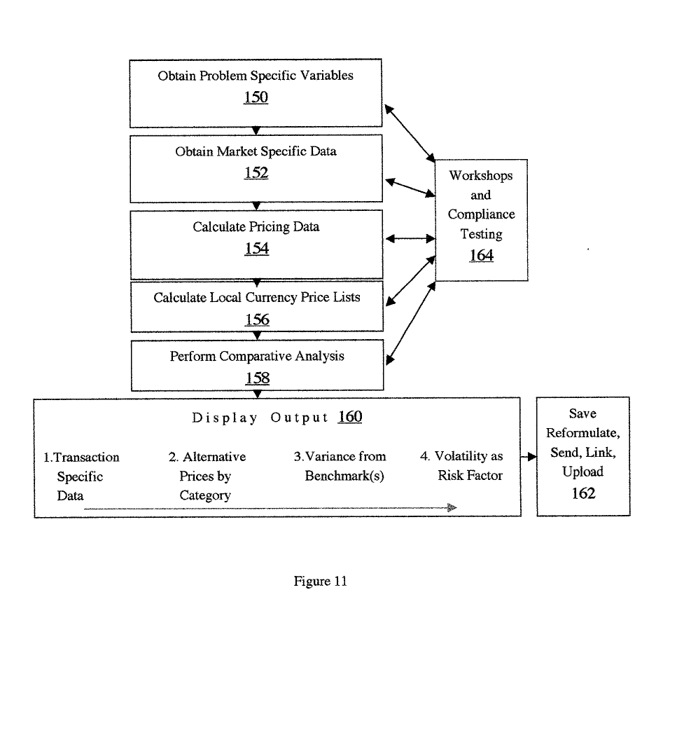

FIG. 11 further describes software components operable to generate the economic exposure model provided through software component 136 of FIG. 10. The returning user may select or indicate the economic exposure model component 136 in order to address questions such as: “if this transaction is priced in US dollars (the “base” currency) rather than in Japanese yen, what is likely to be the impact on our Japanese customer's costs?” or “what is the potential risk to the Japanese company buying our product and paying for it in US dollars?” In the present example, if a Japanese customer is looking to buy the US sourced product, and is required to pay for the product in US dollars, that customer incurs direct currency exposure. For example, such exposure was incurred when the Japanese company buys the US dollars needed to pay its US supplier at some future date no later than 90 days and pays for those dollars in Japanese yen. Accordingly, the Japanese company's exposure may be determined to be the difference between the amount of yen required today versus 90 days in the future, for example. Thus a customer might incur a gain or loss, paying more or less Japanese yen for the fixed amount of US dollars.

For example, the user inputs or uploads situation specific data through software component 150 of FIG. 11, through a formatted sequence of input fields. Examples of such inputs, provided to the software component 150 in connection with the above described pricing scenario might be answers to questions provided by the disclosed system such as: “select base currency of exporter”, “select base currency of importer”, “enter product name”, “enter unit price in exporter's base currency”, “enter percentage margin on product”, “enter budget rate”, “select the calendar (dates) for duration of exposure”, and “select the period for comparison”. Following the input of data through the software component 150, a software component 152 may operate to obtain specific market data including current spot, forward rates, forecasts for designated periods, or historical rates for designated periods by uploading from an external source, or by inputting of selection from the user. Then, a software component 154 operates such that the obtained market data may be used to calculate the pricing on various instruments that might be employed by the user as hedges under various economic scenarios.

Based on the market specific data or pricing obtained by software components 152 and 154 respectively, a software component 156 operates such that the foreign currency pricing alternatives are calculated and a comparative analysis is performed. Finally, a software component 158 operates using the market data to predict the associated risk levels, which may be expressed in terms of ranges of potential costs to the Japanese buyer. The user is given an opportunity to select from the alternative strategies by the software component 158, and the method selected by the user is displayed by another software component 160.

While the US exporter does not have direct currency risk in this situation, its business opportunities will be indirectly affected by currency trends, hence, its exposure is considered economic in that it will evidence itself in variances to sales rather than exchange losses or gains measured in an accounting system. The outcome of various selected methodologies is compared by the software component 158 before a preferred method is selected by the user by the system.

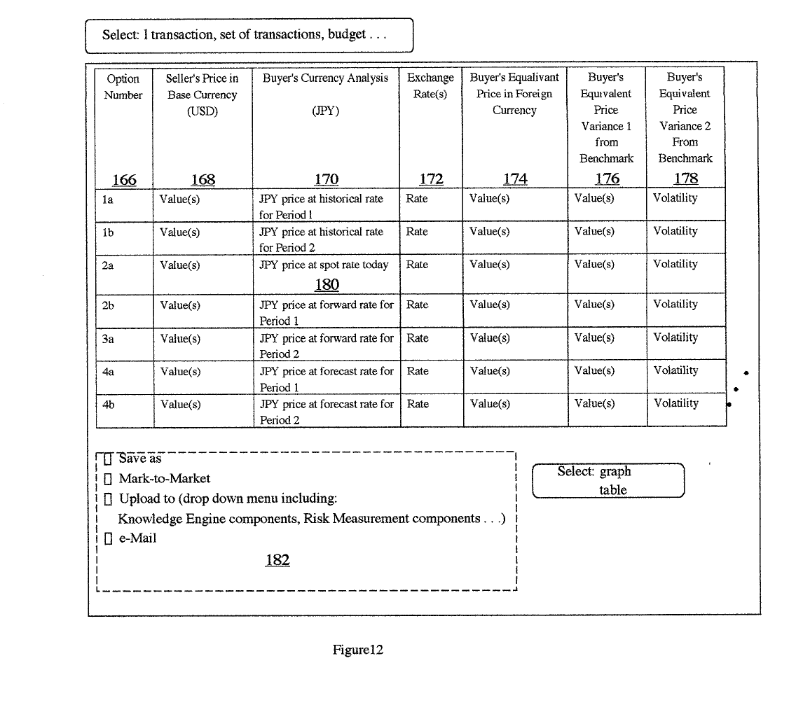

Illustrative calculations made by the software component 158 are presented in FIG. 12. The calculation process shown in FIG. 12 may begin with the exporter's price in its base currency 168, based on alternative strategies 170 and their associated exchange rates 172 or volatility rate that produce an equivalent buyer's price in their home currency 174 on which analysis is performed in terms of values 176 or other benchmarks 178. The results of these calculations may then be used by the user through the options given in the display 182, which include saving the results as a file, emailing the results to a recipient, or uploading the results to another analysis component of the disclosed system.

The software component 160 in FIG. 11 then operates to display the results of the analysis described in FIG. 12. The resulting display may, for example, include : (i) decision specific data, (ii) alternative prices; (iii) variance from a selected benchmark(s); and (iv) volatility as an expression of a common risk factor. The display output provided by the software component 160 creates a concise predictor of economic risk. For example, should a US price be quoted to the buyer requesting a price quote, the model projects, measures and communicates whether the export sale is at risk based on projections of an unfavorable or favorable rate trend and forecasts, as illustrative variables.

The disclosed system permits a decision to be selected by the user through a software component 162. For example, the user may determine that the buyer faces the possibility of a negative price variation of 15% over the 90 day duration of the exposure. This would mean that the final cost for purchasing the US dollars could make the actual price of this purchase to the buyer as much as $15,000 higher than a list price of $100,000. Based on this analysis, the decision may be made to denominate this sale in yen, taking the risk rather than placing it on the customer. Alternatively, the user may create a knowledge base of information that can be utilized in negotiations to produce more favorable results. The system further provides coaching through for example the workshops and technical files regarding negotiating strategies. This analysis can be extended beyond the user own experience to evaluate the import/export variances from any base currency to any foreign currency. Online workshops 164, which are accessible from various entry points, are provided to support training and meet compliance standards related to this decision-making process. Technical files may further be provided through the disclosed system to give short reviews of specific methodologies.

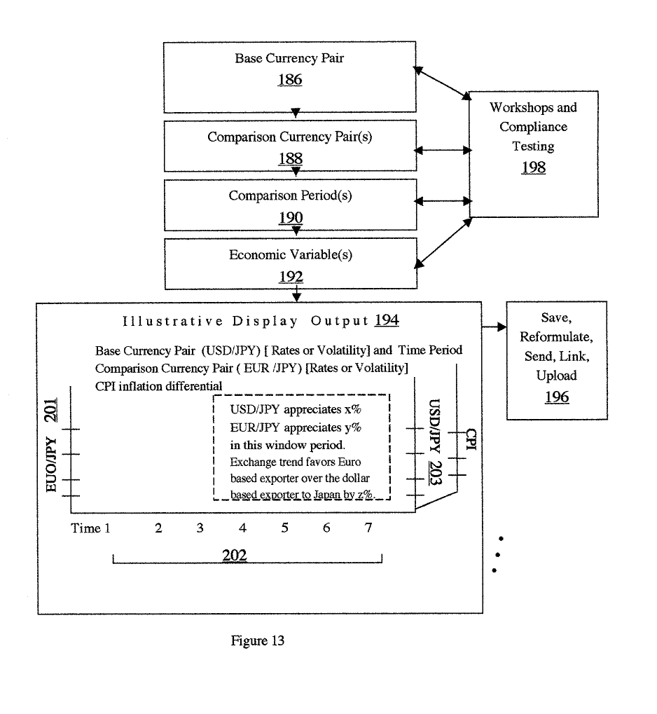

FIG. 13 further describes, for purposes of illustration, the disclosed process for generating the competitive position model performed by the software component 138 shown in FIG. 10. The generated model provides focused analysis of the impact that exchanges rates may play on a competitive position relative to a third party also bidding on the transaction which has a distinct base currency from the returning users. The generated model exemplifies the methodology of the present invention for reducing a complex question and displaying analysis in a succinct manner. It also identifies, educates and provides tools to address a frequent error made with the defined marketplace of users.

In the case of the above described Japanese yen pricing decision, the user may provide information to the disclosed system indicating a scenario in which a US company is bidding for the described Japanese transaction against a French company. Accordingly, the software component 138 generates a competitive position model operative to analyze questions such as: “How may currency risk affect the user's competitors in a given marketplace that have a different base currency than that of the user?”, “How may a Euro based price affect the bidding competition?”; or “Could the Euro present a pricing advantage or disadvantage relative to the US dollar?”

As shown in FIG. 13, at step 186, tiered market data in terms of historic, current or forecast exchange rates for the first currency pair is obtained, in this case for the U.S. dollar and the yen. This data may be input from the user or uploaded from previously entered data. Next, at step 188, a second currency pair, in this case Euro and yen, is similarly input. The comparison period over which the currency pairs are to be analyzed may be selected by the user at step 190. A set of economic variable(s) or variable differentials to be applied during the analysis, for example an inflation rate differential between France and the US, is selected by the user at step 192 for upload into a resulting graph. The disclosed system then performs the user requested analysis and provides an output display such as the output display 194 shown in FIG. 13. The output display 194 is shown, for example, as including an interpretative graph 202 with the first currency pair along a first axis 201 and the second pair along a second axis 203. Both currency pair ranges are proportionately displayed for visual accuracy of the percentage movements of the events portrayed. In this way, a concise visual interpretation is provided which insures accurate analysis of the results by the user. The user can select the percentage presented in the graph among other variables. Further with regard to the example of a US based exporter competing in the Japanese market with a French company, the personalized analysis shown in the display output 194 compares the dollar/yen exchange rate to the Euro/yen exchange rate. If, for example, the dollar has appreciated more than the Euro against the yen, then the Euro based French company may have a currency based competitive advantage over the US dollar based exporter. The process of FIG. 13 provides focused expert analysis that is interpreted to a user's situation, and which provides the returning user with additional valuable information on which to base a pricing decision or enter negotiations. The system provides the user with coaching regarding such potential negotiation strategies through for example the workshops and technical files. An online training workshop 198 may further be suggested to or required of a user in order to ensure that the user understands the associated risks at any point in the process. Finally, an output provided based on the information provided in the display object 194 may be saved, sent, benchmarked, uploaded or reformulated at step 196.

Following completion of the competitive position model software component whose operation is described in FIG. 13, with regard to the user that is evaluating an export sale to Japan, the competing French seller's advantage or disadvantage resulting from exchange rates has been predicted, and the user may factor such information into their decision making. Thus, FIG. 13 illustrates the embodiment of a process within the disclosed Web site technology that focuses on fundamental concepts in a simple, accurate and interpretative way, and which may also provide on-line training consistent with the compliance objectives and features of the disclosed system. Further, it illustrates the concept of content creating commerce, as the user is newly enabled to make decisions and the result of which decisions may results in enhanced sales opportunities for the service provider 15 in FIG. 1 on whose server the service resides.

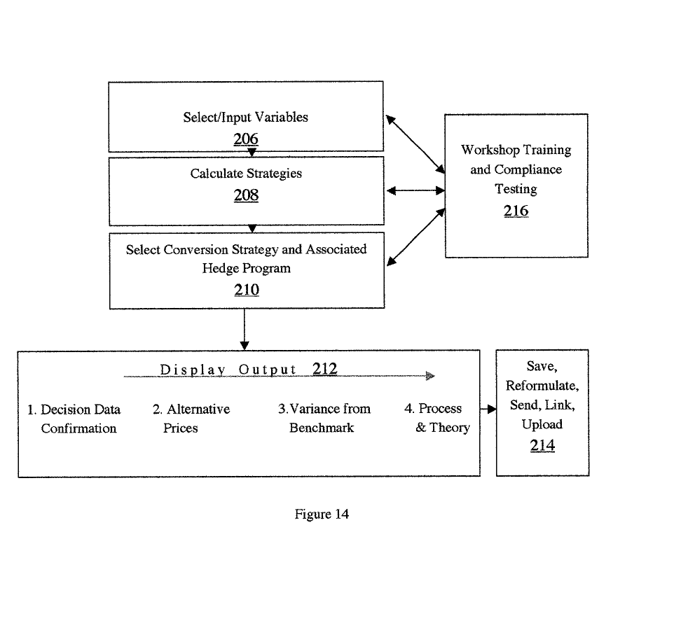

FIG. 14 further process by an illustrative embodiment of the disclosed system during operation of the software component 140 of FIG. 10, which performs product pricing and subsequent budget modeling within the disclosed system. If the user is convinced of the need to provide pricing in Japanese yen based on the previous analysis, a specific price list and subsequent foreign currency budget generated through the product pricing and budget models thus provided includes the necessary conversions, as the result of the process depicted in FIG. 14.

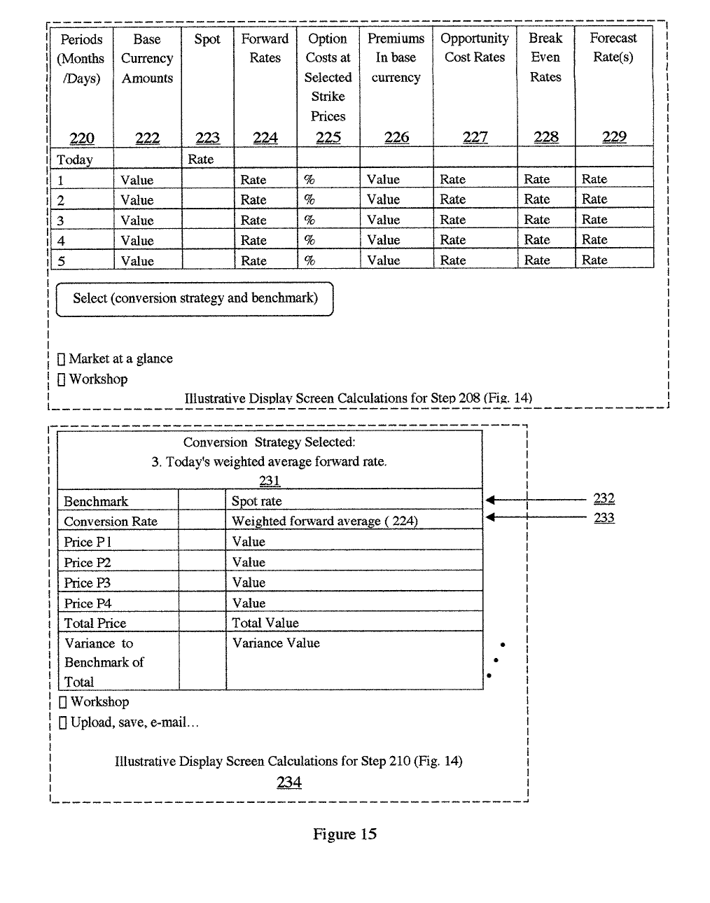

With regard to the example of a US export to Japan, the export value expressed in terms of the US exporter's base currency is input or uploaded at step 206, as a starting point for creating a foreign currency price list or budget. Then, at step 208, the current exchange rates for various instruments that could be applied to hedge this exposure are selected and calculated using a number of predetermined algorithms provided within the disclosed system. An illustrative display of these selected instruments with their resultant exchange rates is presented with further detail in FIG. 15.

A display screen 230 is shown in FIG. 15 for presenting illustrative calculations corresponding to step 208 of FIG. 14. The data shown in display screen 230 include the duration of the exposure period(s) 220 in terms of calendar days, months, or years; the base currency amount(s) 222; the current spot rate 223; the current forward rate; the premium cost 226 as a percentage of the base currency for the selected strike price 225, which is the rate at which the option will be exercised; the opportunity cost of the option expressed as an exchange rate 227; the break even cost of the option expressed as an exchange rate 228; and a forecast rate(s) 229. Based on these instrument pricing calculations and related analysis, the illustrative alternative conversion prices in the foreign currency are determined by the disclosed system in step 210 in FIG. 14, and displayed in step 212. The output display 212 shows (i) the selected hedge program and confirmation of details, (ii) a range of alternative conversion prices, and (iii) analysis of the price differentials, in addition to (iv) the process definition and theory behind each alternative selection. A request in step 214 to save, reformulate, send, link upload or monitor the rate(s) associated with this price(s) may then be made to the system. Additionally, the rate(s) may be set as a benchmark(s) for use in connection with the system operation associated with current market analysis in steps 62 and 68 in FIG. 5. This is one example of the benchmarking and integration capabilities provided by the disclosed invention.

The output display in step 212 in FIG. 14 is further defined for illustrative purposes in FIG. 15. FIG. 15 depicts the calculations for a selected conversion strategy in a table 231, from among the possible alternatives and provides a selected benchmark(s) 232 for purposes of analysis. It may be displayed in a smaller sized new window. The conversion rate(s) 233 correspond to an underlying risk management strategy(s) associated with a user, and the selection by the user of an alternative conversion price suggests implementation of a hedge program to protect that conversion price. This hedge program may be uploaded directly into other system capabilities, for example into the risk management capability in FIG. 2 Step 34. Workshops in step 216 in FIG. 14 provide training to support the decision making process associated with the process shown in FIG. 14. The methodology for developing the exchange rates for annual budgets using the above methodology is also provided by the disclosed system.

The features of the disclosed system providing value to the target market segment include a methodology for determining foreign currency price lists and budgets, integration of currently priced risk management instruments into the pricing decisions, integration of a range of economic scenarios, the ability to benchmark and monitor exchange rates associated with strategy implementation easily, and the timesaving it provides.

Following performing the steps described above, the user has achieved important milestones in the exposure risk management process. In summary, these milestones include: (i) training in exposure management including direct and related topics in response to user profile and problem specific information, (ii) gaining a working knowledge of the markets and instruments relevant to a user profile and problem specific information provided by the user, (iii) developing knowledge necessary for developing a governing risk policy, and (iv) use of a methodology for establishing foreign currency price lists and budgets. The user may decide, subject to having obtained any necessary authority, that the transaction will be priced in Japanese yen with the customary credit terms of the user's company extended, 90 days open account. As a result of this decision, the Japanese buyer will not need to pay until 90 days from the invoice date, and they will be able to make payment in Japanese yen. This assures the Japanese buyer of a fixed price in their own currency. By reducing the buyer's risk, the exporter's opportunity for business increases.

The returning user is now prepared to book a Japanese yen denominated accounts receivable using the disclosed system. However, before actually booking this foreign currency receivable, the disclosed system establishes, as permitted under the governing policy configured for that user, whether any applicable, previously established limits and controls are in place for the transaction. Such limits and controls might include currency exposure limits by country, limits on the period of time permitted for any exposure, limits on the types of instruments permitted for hedging, or limits on the specific hedging strategies permitted. To assure meeting “know your customer” compliance standards in the banking industry, the disclosed system therefore requires that policy configuration is complete prior to allowing a user to access certain features, such as entering a foreign currency receivable into the system, entering a foreign currency budget into the system, or transacting a trade to initiate a hedge using the system. Because of differences among countries in compliance standards, selected standards may be de-selected by the service provider 15 in FIG. 1.

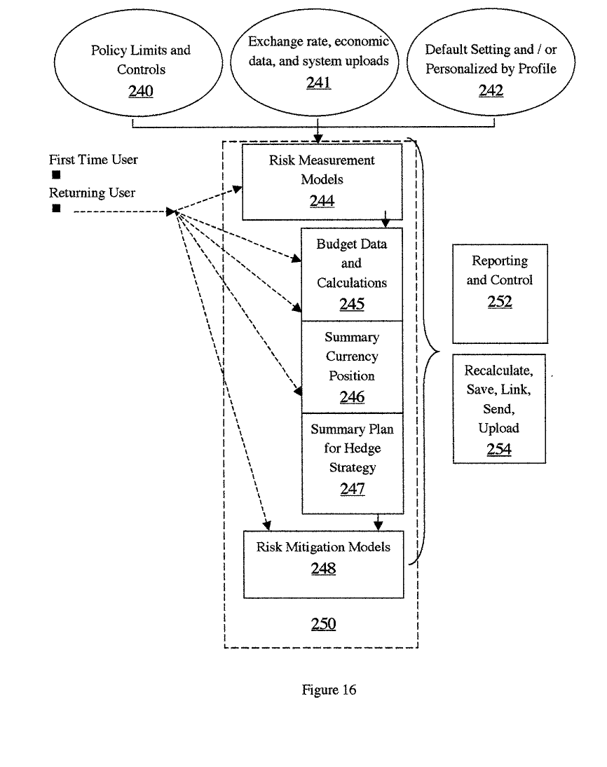

Now that the user understands how to convert the export sale into Japanese yen, and has created a Japanese yen price list, the user may be uncertain as to how to create a budget for foreign currency exports, or how to book the transaction consistent with generally accepted accounting standards for the US. Further, the user may understand that the user's company policy requires that a hedge be initiated to protect the company's margin on the export sale against currency fluctuations. So the user then invokes software component 34 illustrated in FIG. 2, in order to perform risk measurement and mitigation, in order to obtain further guidance. FIG. 16 illustrates the process underlying the operation of software component 34.

As shown in FIG. 16, the disclosed system provides users with a plurality of decision support models that create a powerful progressive methodology for creating a foreign currency budget, booking foreign currency based business, and hedging or offsetting the associated risk. Inputs to the software components 250 include previously established policy controls and limits 240, real-time tiered exchange rates, volatility rates, economic data, and other system uploads 241, and a default or personalized user profile 242. These inputs are used as the basis for the system to calculate conversions and perform analysis, and therefore provide the key components to decision making. The system initially directs the user to use the software component 244, which provides a risk measurement model consisting of three progressive steps to record and budget a Japanese yen accounts receivable.

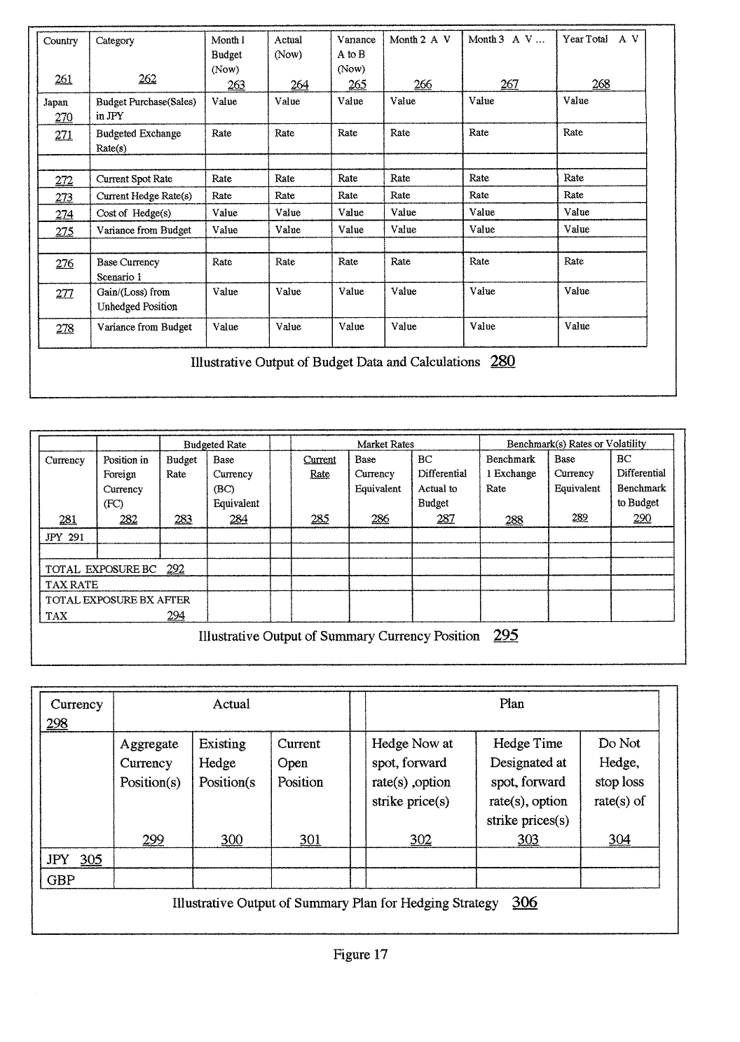

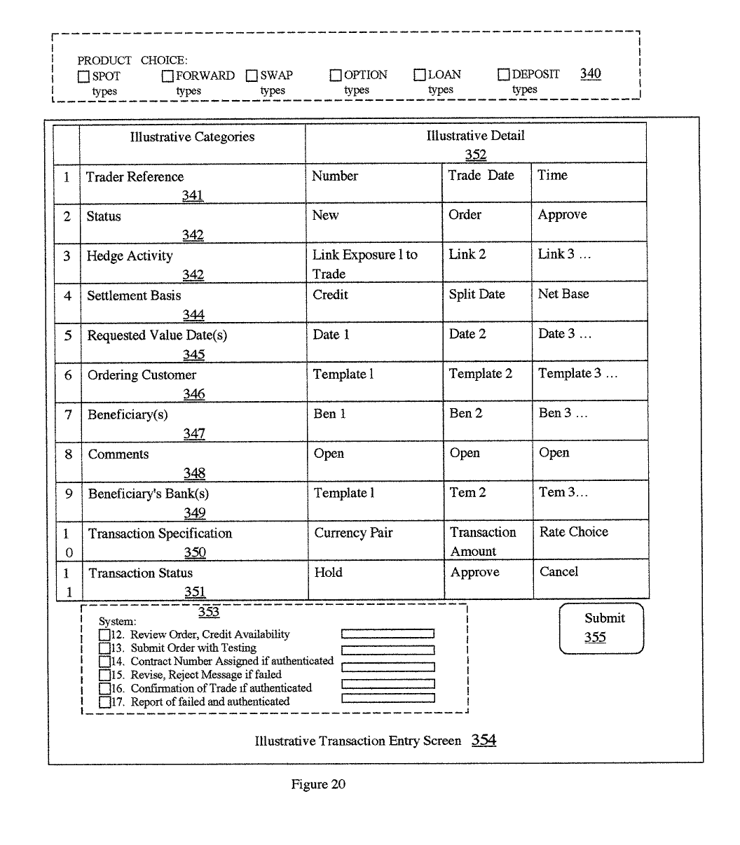

The user may then employ the software component 245, in order to enter budget data and perform related calculations. The operation of the software component 245 is further illustrated by the displays shown in FIG. 17. Through the software component 245, the user may record the yen denominated transaction through a screen entry requesting such transaction specific data as “currency”, “currency amount”, “date of transaction”, “date of maturity”, “beneficiary”, “beneficiary's bank”, “beneficiary's address”, and “hedge designation” into respective input fields which will then be uploaded into the system. This upload may include a single or aggregate by currency of the foreign currency denominated transactions into the transaction entry screen in FIG. 20. These data elements are then output as shown by the display screen 280 illustrated in FIG. 17. The output display 280 suggests by country 261 a range of categories 262 on which to base an analysis. Budgeted purchases and sales in foreign currency by month 1 263, month 2 266, and month 3 267, through selected future months are reported against actual 264, with variances 265 between actual and budget and selected totals for the fiscal year 268 with variances to actual. Specifically, the budget exchange rate uploaded based on the conversion obtained at 210 in FIG. 14 is reported, for example with the current spot rate 272 and forward rate 273, with the cost of the forward hedge 274 in base currency terms and variance from budget 275. Further, specific exchange rate scenarios, such as the exchange rate scenario 276 or market volatility, are entered or uploaded from forecasts as illustrated in the long term trading ranges 78 display object within the current market analysis reports of FIG. 6. The potential gains or losses associated with an unhedged position are shown at 277, and the resulting variances from budget 278 are also shown. These display components serve to highlight to the user the degree of risk associated with the current transaction, in order to motivate the use of hedging instruments, sales of which is provided through the service provider. Additionally, these display elements represent a further technique for assuring compliance standards are met using the disclosed system.

Further as shown in FIG. 16, a software component 246 is provided which summarizes all budgeted and actual exposures for the user. Such reporting is displayed in the output display object 295 of FIG. 17. By currency 281, and/or by currency groups, the total position in foreign currency 282 is therein displayed, together with the budget rate 283 and the base currency equivalent 284 of the foreign currency. Calculating the base currency equivalent 284 assists the user in understanding the degree of risk involved in a business activity, and also allows aggregation of a company's total exposure at 292, on a before or after tax basis 294. For evaluation purposes, the budget and actual are marked-to-market using current rates 285 and value-at-risk methodology (VAR) to calculate the current base currency equivalent 286 and the variance between actual and budget rates 287. Benchmark rates 288 can then be applied with the base currency equivalent and variance calculated for each benchmark selected. This process provides the user concise, up to date exposure tracking and reporting consistent with the disclosed “in-and-out” methodology

Further in FIG. 16, a software component 247 of the disclosed system provides a process for developing a summary plan for hedge strategy. An illustrative output display object 306 in FIG. 17 shows output from the software component 247. In the display object 306, the underlying currency position 299 is compared, by currency or by currency group, to the existing hedge position 300 in order to determine the current open position 301. Based on these calculations, the summary plan may be formed under multiple alternative strategies. The plan utilized in determining the conversion price at 210 of FIG. 14 is uploaded and reported as shown at 302, as the basis for default hedging activity. An override of the default is permitted through the disclosed system, in that the software component 254 operates such that target exchange rates indicated in the summary plan may be recalculated, saved, linked, sent or uploaded. They may also be entered as benchmarks for viewing through the display object 76 of FIG. 6, for easy monitoring and e-mail notification of levels relative to market rates that are established through the hedge strategy component 306 in FIG. 17 for hedging later 303 or stopping losses 304. Consistent with the compliance features of the site, hedge activities are subject to authorization through software component 252 in FIG. 16. This provides the returning user with a concise overview of exposures and the associated hedge plan(s) consistent with the disclosed “in-and-out” methodology. It further illustrates the design of the site to create commerce from content.

Further during operation of the software component 248 shown in FIG. 16, the user might begin to evaluate risk mitigation strategies or the selection of instruments relative to alternatives defined by or established through the policy configuration software component 30 shown in FIG. 2.

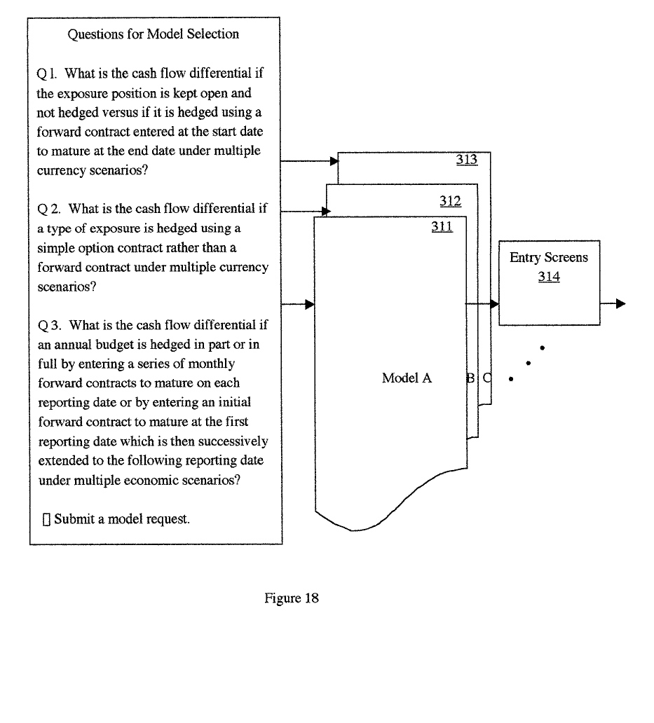

The processing of the system in connection with operation of the software component 248 in FIG. 16 is driven by the user's selection from questions 310 shown in FIG. 18, which are associated with corresponding ones of a plurality of models 311, 312 and 313. Questions provided by the software component 248 for selection by the user may, for example, fall into three categories. These categories of questions are illustrative of the technical aspects of the decision making requirements of target market in this regard. In the first category are questions for selecting the most effective instrument under specified criteria, such as maximizing cash flow and/or exchange rate forecasts. Illustrative questions within this category include (i) “Which class of instrument should I use to hedge an exposure?”; (ii) “hat is the most cost effective instrument to hedge a measured exposure on a cash flow basis given my exchange rate forecast?”; (iii) “Should I hedge this exposure set using a single delivery date or variable delivery date on the forward?”; (iv) “Should I hedge this exposure set using an instrument (i.e., forward or option contracts) or the money markets (i.e., loans or deposits)?”. The basis of support provided by the system comes from technical analysis requiring expertise not generally characteristic of the target market and the use of current market rates from which transactions can be effected and the timesaving and accuracy associated with use that can provide for delegation of activities.

In the second category are questions that address the judgment errors common to the target market segment. Illustrative questions in this category include: (i) “Should I enter foreign currency loans to take advantage of lower interest rate structure in other currencies?”; (ii) “Should I place funds in higher yielding foreign accounts?”; or (iii) “Should I use a Non-Deliverable forward contracts or a Deliverable forward contract?”.

A third category of questions addresses the choice of hedging strategies. An illustrative question in this category includes: (i) “Is it more cost effective to hedge an exposure set over a period of time by entering a series of contracts to match the periods of exposure one-for-one, or alternatively to enter a single contract to mature at the end of the first period and then extend it at the close of each successive period?”. The disclosed system responds to these questions concisely and instructively, and in so doing provides the returning user with cash savings through the selection of preferred actions, as well as through the accuracy of the provided analysis, resulting also in time savings through the automation of such analysis using real time, tiered rates.

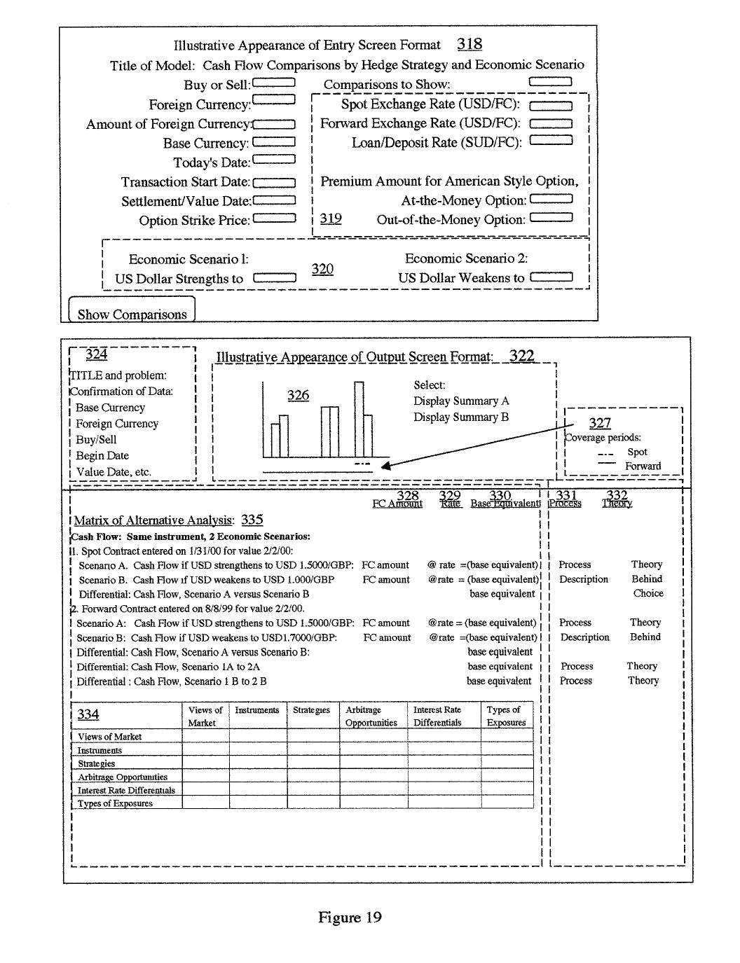

Once an appropriate model is selected, the entry screen 314 for the selected model is accessed. An illustrative appearance of such an entry screen is shown in FIG. 19. This is an exemplary embodiment of the disclosed system. The input screen 318 of FIG. 19 reflects input or uploaded data relative to the underlying exposure(s), and includes a request for selection of relevant comparisons, for example, a range of hedging instruments. The disclosed system then uploads current tiered rates and calculates required pricing 319, using predetermined algorithms within the disclosed system. After uploading or inputting economic scenarios through the window 320, the user may request the system to “show comparisons” by clicking on a button within the display.

As a result of the “show comparisons” request, the disclosed system opens a new window with an exemplary illustrative output display object 322 displaying the results of the hedging model. The output display object 322 confirms the model title, restates the problem objectives, and confirms entered or uploaded data 324. The results summary 326 displays in graphic form multiple variations of analysis, and shows the relevant hedge coverage periods 327. The matrix 334 shows the basis for the matrix of alternatives analysis 335. The matrix of alternatives analysis 335 includes, for example, the model selection, the basis of calculations such as maximizing cash flow, the instrument types, and the economic scenarios involved. The analysis performed by the disclosed system to provide the output shown in the matrix of alternatives analysis 335 may be based on multiple matrix variables. For example, these matrix variables may include 1) market view A, market view B, market view C, . . . 2) instrument choice A, instrument choice B, instrument choice C, . . . 3) strategy selection A, strategy selection B, strategy selection C, . . . 4) arbitrage opportunity A, arbitrage opportunity B, arbitrage opportunity C, . . . 5) interest rate level A, interest rate level B, interest rate level C, . . . , and 6) exposure type A, exposure type B, exposure C, . . .

The hedging process is detailed, with differentials calculated between relevant criteria, such as for illustrative purposes, differentials in cash flow under multiple economic scenarios when using the same instrument to hedge. The foreign currency amount 328 is also displayed, and the applicable exchange rate 329 is used to determine the base equivalent 330 from which differentials are calculated in base currency terms. Finally, the process 331 is displayed, with detailed provided by selecting such in a new smaller window and the theory 332 behind the determined selection of hedge instrument reviewed with links to related workshops. Throughout the display in FIG. 19, mouseovers provide definitions of technical terms for quick reference.

The risk mitigation models depicted in FIG. 18 analyze a plurality of complex risk strategies, utilizing various hedge instruments under various economic scenarios. These models are designed to prevent the errors most frequently associated with risk management decision-making within the target market. They further depict the range of decision making required by this market segment. The models can be relied on to select preferred risk strategies out of alternatives, and to determine preferred instruments out of alternatives, as well as to determine strategy or instrument preferences based on alternative economic outlooks. As a result, they provide time, cost and knowledge efficiencies. The risk models in FIG. 18 may further continually evolve in response to client needs, and in order to create a community among users. It is further intended that the models provide training by revealing common errors in calculations and in judgment made by non-expert users, thus enhancing further compliance standards in the system.

Further with regard to the user's Japanese yen hedge decision, for illustrative purposes the user selects the model 311 in FIG. 18 that provides for evaluation of cash flow differentials dependent on a matrix of alternatives. The matrix of alternatives which may, for example, include: 1) the strategy selected for purposes of illustration above, to keep the position open and convert the yen receivable using a spot contract in 90 days or which may include such a choice as to hedge serial exposure periods using a series of hedges or a single hedge for the initial exposure period that is then extending it at the start of successive periods; 2) the instrument selected, for example, a spot, forward contract or an option contract; 3) the exchange rate scenario anticipated such as the preferred instrument when a view of the currency is held or no view is held; or 4) arbitrage opportunities. In this instance, based on policy, the user's goal may be to fix the rate today for the conversion of the Japanese yen accounts receivable that will settle 90 days in the future. This rate may be the forward rate or it may be the put option with a selected strike price, for example, depending on the type of range of hedge instrument selected. This may further depend on the range of selections made available by a financial institution with which credit facilities are established and which is the service provider bank on whose web server the system resides. Variables limiting the selection of instruments may be credit terms, but also sizes of transactions and currencies. The system informs the user regarding market or institution based exclusions and may provide corrective actions. Based on the selected comparisons to show, the system uploads calculated exchange rates, tests the trading and settlement dates for validity, determines the strike price(s) is warranted, and calculates the premium for options, as illustrative variables. Forecasted exchange rate ranges determined in connection with the market knowledge components of the disclosed system or from other sources may be uploaded or input.

Further in output display object 322 of FIG. 19, the relevant supporting data for the analysis may be confirmed in the display object 324. A number of alternative graphic displays are selectable provided in the display object 326 with regard to a number of alternative summaries, and the protection period 327 on which such displays are based may also be selected by the user. Accordingly, and as shown in FIG. 19, the detailed analysis provided by the disclosed system supports compliance standards by providing detailed disclosure of the process and calculations being made to arrive at a final determination. A matrix 334 of alternatives relative to instruments, strategies, and economic scenarios may be presented, for example, and the user might for illustrative purposes select the appropriate options to compare the cash flow when employing the same instruments under two economic scenarios. Or, alternatively, the user might compare alternative instruments under the same economic scenarios. Or, as another example, the user might compare alternative strategies under the same economic scenario.

The user might select a type of put options within the display objects shown in FIG. 19 in order to compare the cash flow described in the display object 334, resulting from the use of the same instrument under two different economic scenarios. The system would then upload the current tiered exchange rates for display in the column 329 as applied to the pricing of the instruments shown in the analysis matrix 334. The resulting rate is then used to convert the foreign currency amount shown in the column 328 that is being managed into the base currency equivalent for display in the column 330 in order to compare cash flow under the two scenarios. Further, in an exemplary embodiment of the disclosed system, the process for the corresponding selection is summarized in column 331 with additional detail available through a new smaller window. The theory 332 behind the selection is presented with an alternative for linking to a workshop or technical report for further training or assistance in decision making. The screen objects shown in FIG. 19 further support the compliance and sales features of the disclosed system.

The user is now prepared to make a decision regarding the hedge transaction and initiate a transaction with the institution or service provider providing the disclosed system, as shown in the transaction initiation software component 40 of FIG. 2. When the user initiates a transaction, the request passes through a series of software implemented compliance tests regarding multiple variables relating to the users authority, the relevant policy limits, the rate calculations, and the user or company's short term or long term transaction history.

Further with regard to transaction initiation through the software component 40 of FIG. 2, the user may employ another entry screen, or may select from a number of product choices provided in the screen object 340 shown in FIG. 20. A number of drop down menus may be provided to show selections by category of product. The user then enters or uploads the following eleven transaction control categories of information on the illustrative transaction entry screen 354 in FIG. 20. trader references 341 (such as number of the trade, trade date, trade time . . . ), status of trade 342 (such as new, order, approve, warehouse . . . ), hedge activity represented 342, (such as link to underlying transaction 1, 2, . . . ), settlement basis 343 (such as credit, cash, . . . ), requested value dates 343, ordering customer 344, beneficiary(s) 345, comments 346, beneficiary(s) bank(s) 347, transaction specifications 348 (such as currency pair, transaction amount, rate choice, premium amount . . . ), and transaction status 349 (such as hold, approve, cancel, delete . . . ). The system allows the user to select and upload multiple booked accounts payable or receivable denominated in the same currency that are identified by a hedge designation into the transaction entry screen as an aggregate purchase or sale with the total amount of that aggregate displayed in the contract entry screen. They system further maintains the identity of the aggregate transaction in order to settle individual accounts from a single hedge transaction. The user then submits the order through the button 355, at which time the transaction system reviews the order as provided in the status display object 353 checks credit availability, and submits the order following multiple tests for accuracy of transaction variables or parameters. A contract number is then assigned if the transaction is authenticated, or a reject message is generated if the transaction failed, followed by a confirmation of trade number if it was authenticated or a report if failed, and an aggregate report of all authenticated trades for a given user or company.

Further, with regard to transaction initiation, booking, and reporting in the software component 40 of FIG. 2, the disclosed system provides the following capabilities: 1) to password protect various options provided to the user, 2) to offer encryption and virus protection, 3) to specify access rights to both groups and individuals by multiple variables, 4) to close out the transaction screen if inactive for too long, 5) to allow the user to display current rates without making a trade, 6) to display rates from any base currency, 7) to override assigned rates according to predetermined authorities, 8) to provide multiple tiers of rates for margin mark ups for different categories of users, different products and categories of transaction sizes, 9) to notify the user that rates are current, 10) to test that rates are accurate, 11) to capture rate feeds, 12) to maintain an international holiday calendar and block trades on unauthorized dates out one year, 13) to execute and price online real time rates for varieties of spot, forward, swap and option contracts as well as loans and deposits, 14) to deal directly with a dealer, 15) to assign a contract number when the trade is released, 16) to assign the rate when the trade is released, 17) to log and authorize the initiator, approver and releaser of every trade with report of time, location and date of trade, 18) to enable a user to purchase/sell a block of one currency and make multiple payments/deposits, 19) to update portfolio positions on release of the transaction, 20) to manage currency exposures according to policy controls via system limits, 21) to capture profit margins per customer, per transaction type, per currency, and trader, and for an entire business over various time periods, 22) to support negative spreads indicated in the pricing tiers, 23) to track declined trades per customer and get the percentage executed, 24) to license the service and have feeds enter the system, 25) to stop trading in any particular currency immediately, 26) to stop trading with any particular customer immediately, 27) to generate reports of exposure in total and by currency, by customer, by amounts, by time, by trader, and by limits among other variables, 28) to receive automated credit line uploads, 29) to provide cut off times for customers which can be validated, 30) to set daily limits per currency per customer per trader and in aggregate, 31) to require two approvers on designated sizes and type of transactions as measured in any base currency, 32) to meet SWIFT (Society for Worldwide Interbank Financial Telecommunication) international standards for payment and information messaging, 33) to support ABA numbers and beneficiary SWIFT addresses, 34) to designate communications to customers, 35) to produce confirmation on screen and in print via SWIFT and provide automated confirmation, 36) to maintain historical databases of transactions sorted by a range of variables, 37) to track float and fees, 38) to export files, 39) to create and store templates for repeat transactions, 40) to maintain number assignments of contracts including discarded ones, 41) to create account entries and manage general ledger entries, 42) to define base currency in a multicurrency environment, 43) to maintain an audit log of who initiated, approved, released all transactions, profiles, templates or other field entries or changes, 44) to initiate payments to/from a third party via multiple platforms, 45) to warehouse transactions for future release, 46) to consolidate multiple currency positions, 47) to track balances, 48) to self proof, 49) to validate all data entries provided by a user, 50) to place orders at specified levels and have the order immediately placed or monitored for a specified duration, 51) to designate a trade as a hedge and capture the underlying transaction for an uploaded file according to pre-designated criteria such as customer name(s), product category(s), hedge designation(s) or invoice number(s), 52) to personalize transaction screens, 53) to mark-to-market transactions using value at risk methodology, 54) to price bid/offer points, 55) to determine transaction values from the base currency equivalent, and to 56) aggregate uploaded data representing multiple individual exposures to multiple parties in the same currency into the transaction specification 350 category for hedge in aggregate using one contract and one rate which exposures are linked to that contract for individual settlement.

Following initiating a transaction through the software component 40 of FIG. 2, the returning user has achieved another important milestone in the exposure risk management process by entering a hedge transaction. The user now needs to complete the risk management cycle. Guided by the disclosed system, the user now traverses the disclosed web site through the software component 36 for reporting and control functionality, as shown in FIG. 2. Alternatively, entry of transactions may be performed through an alternative front end interface provided by the service provider, such that transaction files are uploaded into the disclosed system through a conventional protocol.

The reporting and control software component 36 governs processing of hedge activities, including confirming, booking, netting, processing, paying, reconciling, tracking, monitoring, reporting, marking-to-market, as required by financial reporting under standard accounting practices by country of operation. In so doing, the disclosed system generates the required accounting entries through a file transfer under a standard protocol, consistent with country specific accounting standards, into the domestic accounting system. Reporting generated by the disclosed system is comprehensive and forms the basis for monitoring of limits and controls. These reports include, for example, the following reports: foreign exchange position report in detail and summary forms; Income Statement report; Balance Sheet report; contracts outstanding report; net open position report; gap position report; counterparty report; confirmation report; contract history report with mark-to-market capabilities; trading lines and limits report in aggregate and with usage and exceptions; a summary position report by counterparty, currency, and country; and Pro Form Income Statement and Balance Sheet.

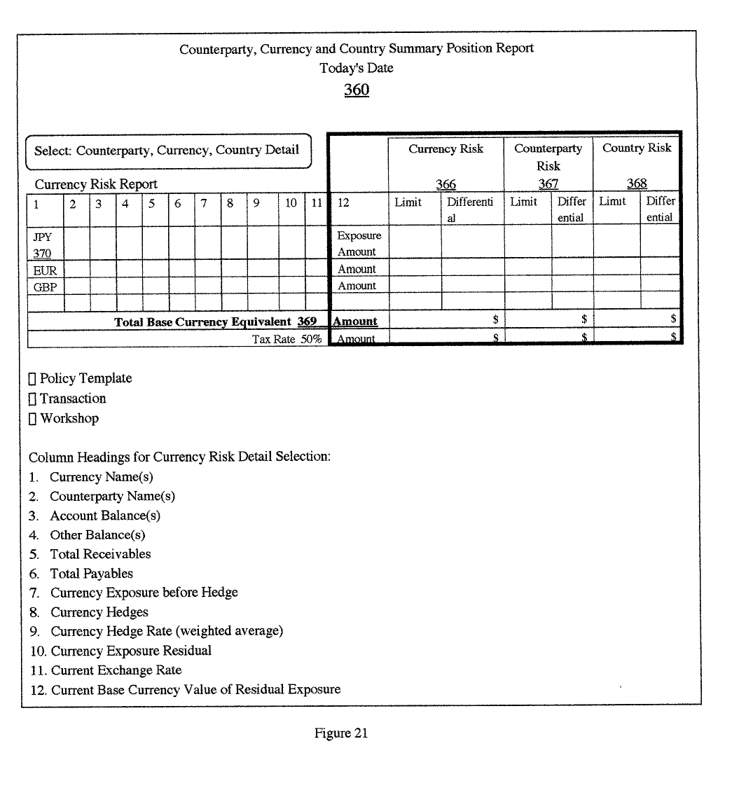

Further with regard to software component 36, an exemplary report of the disclosed system is the illustrative summary position report 360 depicted in FIG. 21. For each currency given in the column 370, other columns in the report screen display counterparty names, account balances, other balances, total foreign currency payables and receivables, currency exposure before hedging, currency hedges, currency hedge rates, residual currency exposure, current exchange rates, and current base currency value of the residual exposure are reported. The summary counterparty risk 366, summary currency risk 367, and the summary country risk 368 are calculated and displayed in relevant base currency. This report is uploaded into the other parts of the system, including for example, the country specific reports shown in the screen objects of FIG. 7. This functionality demonstrates the values brought to the user by the disclosed system in terms of concise reporting that saves time and presents an overall picture based on current information. Further, this functionality supports the “in-and-out” methodology of the disclosed system by allowing the user to update their knowledge of the business relative to current market conditions quickly and accurately, receive only the key information needed, and then go about their other responsibilities. The disclosed software component 36 thus forms a core element in the exemplary compliance process embedded throughout the disclosed system.

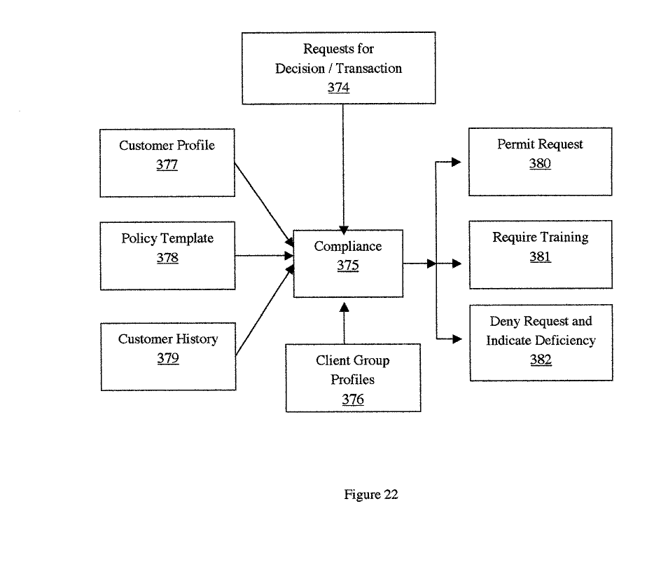

The compliance software functionality 375 of the disclosed system is further depicted in FIG. 22. On behalf of the service provider on whose Web server system 14 (FIG. 1) the disclosed system resides, the disclosed system establishes client group profiles 376. The client group profiles include, for example, margins on rates used for displaying rate data, or used for calculating pricing of various product offerings, credit categories, and/or line availability. These margins may be determined as illustrative based on a user's credit rating, volume of transactions, and profitability. In addition to any service provider established controls, users also establish compliance features under standard protocols that are then embedded into the disclosed system. For illustrative purposes, the disclosed system provides three sources of client established controls which are pulled into the compliance function 375. These are: 1) the customer profile 377 completed through software component 26 (FIG. 2); 2) policy limits and controls 378 created in the policy configuration software component 30 (FIG. 2); and 3) the customer history 379. The disclosed compliance functionality 375 system monitors, governs, and reports on every aspect of the system on an integrated and real time basis. In response to operation of the disclosed compliance functionality 375, the disclosed system may alternatively permit a request at 380, require automated training such as an online course at 381, or deny the request at 382 and indicate the user's deficiency and corrective actions.

With respect to the above described example user activities, the risk management process has now come full circle, and the desired business results have been achieved. Empowered by flexible and integrated tools and technology delivered through the disclosed system, the user has utilized the 5-step process defined by the software components 28, 30, 32, 34 and 36 shown in FIG. 2 in order to: (i) assess and monitor the level of currency risk, (ii) establish the currency price list, (iii) budget for and book the receivable using generally accepted accounting standards, (iv) protect the margins by hedging the receivable under generally accepted accounting standards, (v) meet reporting requirements under governing accounting standards, (vi) monitor positions, and (vii) control the process from start to finish employing best practices standards. The user has also completed this process under software implemented controls, including controls set by the entity on whose Web server the disclosed system resides.

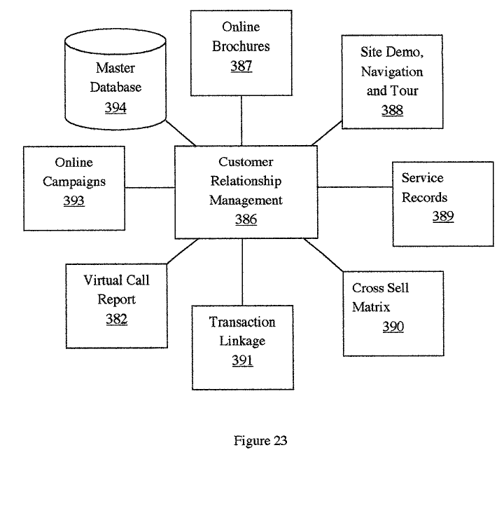

Supporting the risk management advisory service herein disclosed is a customer relationship management (CRM) 386 software application illustrated in FIG. 23. A cluster of services is available to the service provider through business rules stored in the master customer relationship management (CRM) database 394 in order to market the service, measure use of the service, support customers and predict needs. These features include for illustrative purposes: online brochures 387; online campaigns 393; online navigation, demos and tours 388; online call reports 382 with product and cross selling matrix 390; and service use records 389. Additionally, to increase transaction sales, all these functions link directly to transactions sources 391 for immediately implementation of decision-making.

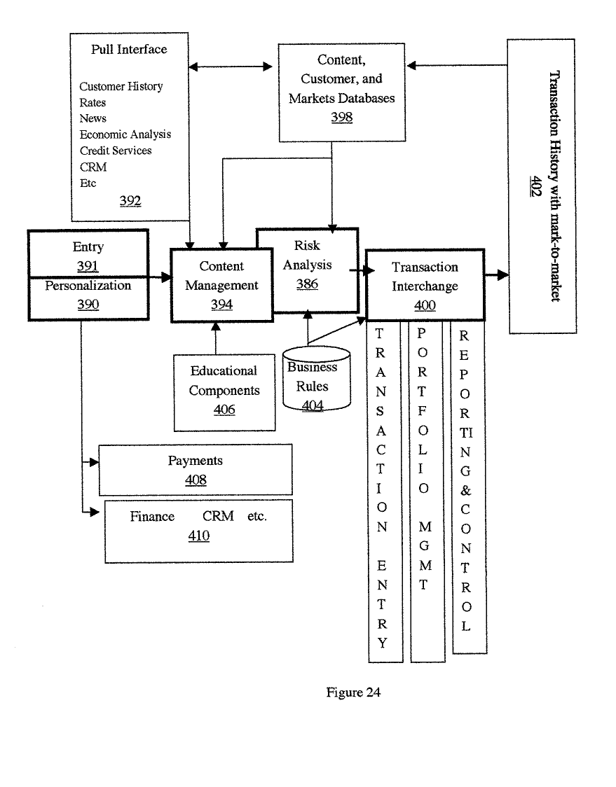

The inter-relationships of various application software components employed in an illustrative embodiment of the disclosed system are shown in FIG. 24. These components may be programmed in, for example, Java, JavaScript, Active Server Pages, Web dB, and/or PL/SQL programming languages, and may be serviced through databases such as Oracle 8i. As shown in FIG. 24, an access management application 391 governs a customer entry and personalization application 390. A pull interface application 392 pulls data from various external sources into a content management application 394. In addition, it is also fed data from the education delivery applications 406. The risk analysis applications 396, are also fed by the market content databases 398. The risk analysis applications 396 and transaction interchange applications 400 are governed by a data set of proprietary business rules 404. Also, the transaction interchange application 400 has the capabilities for Transaction entry, Portfolio Management and Reporting and Control. Transaction History 402 collects data on all transactions from the transaction interchange 400 into a database such as Oracle 8i. A payments application 408 is used to accept payment instructions from an electronic commerce application and route payment data to and from various related payment systems. Finally, financial and customer relationship management (CRM) applications 410 are also interfaces to the system through the personalization functionality 390.

The foregoing example of a user solving a business problem with the disclosed system, in which the very simple decision of pricing a single export sale in Japanese yen, is intended to suggest the many uses of the disclosed invention that in reality are wide ranging and complex. The many corporate enterprises within the targeted market for the disclosed system, that are involved in international trade and investment, will utilize this disclosed system in strategic and tactical ways as a result of its great versatility. Likewise, service providers offering the diverse services of the disclosed system to the target customer group on a self-help basis may rather or at the same time have its advisors utilize the services on behalf of clients in order to support the delivery of personal services utilizing the efficiency, accuracy, and broad resources of the disclosed system.

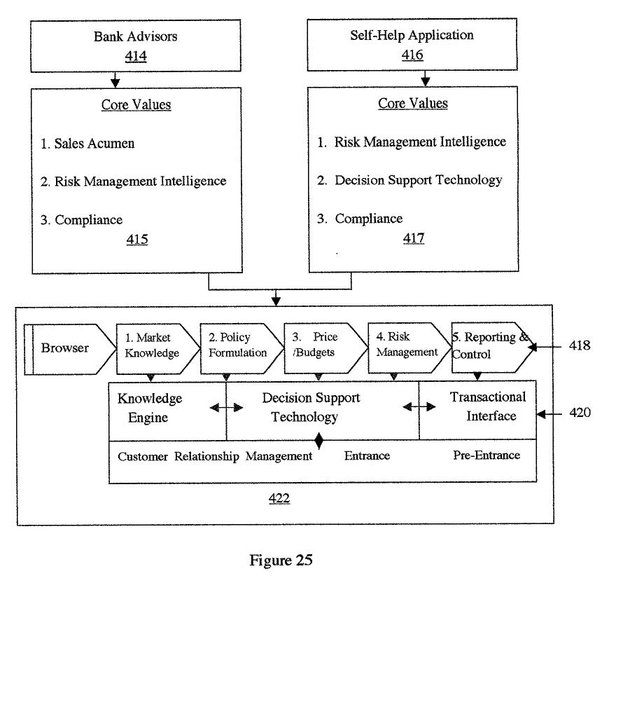

As shown in FIG. 25, for bank advisors 414, the disclosed invention increases their productivity through the following features: supporting sales calls any time and where utilizing effective technology to solve a wider range of problems immediately and effectively; allowing quick and effective strategy development; delivery of broadened services; and providing access to consistent and accurate decision-making. As a result, the service delivery capabilities of bank advisors are improved, and a competitive advantage is created that transform relationships with this market segment. At the same time, the disclosed system creates the opportunity for new revenue streams, enhances sales opportunities across business lines, and assures compliance standards. Finally, the disclosed system effectively manages marketing, sales and service delivery. Consequently, it presents core values 415 that include proven sales acumen, cumulative risk management expertise, and state-of-the art compliance standards.

When used as a self-help application 416 directly by the target market, the disclosed system delivers core values 417 including expertly developed step-by-step risk management expertise, the tools and technology to support the required decision-making, assurance of accurate reporting, prudent controls, and opportunities for community generally accessible to the customer for the first time. These result in cost, time and information advantages that do not presently exist. Further, by accessing an integrated solution all at one place to meet specialized complex needs, relationships are fostered within the community established and with the service provider. Together through the summary process 422 depicted in FIG. 25, bankers and their customers relate in new ways that mutually support international business opportunities.

Those skilled in the art should readily appreciate that programs defining the functions of the disclosed system and method for determining deadlock free routes can be implemented in software and delivered to a system for execution in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using baseband signaling or broadband signaling techniques, including carrier wave signaling techniques, such as over computer or telephone networks via a modem. In addition, while the illustrative embodiments may be implemented in computer software, the functions within the illustrative embodiments may alternatively be embodied in part or in whole using hardware components such as Application Specific Integrated Circuits, Field Programmable Gate Arrays, or other hardware, or in some combination of hardware components and software components.

While the invention is described through the above exemplary embodiments, it will be understood by those of ordinary skill in the art that modification to and variation of the illustrated embodiments may be made without departing from the inventive concepts herein disclosed. Accordingly, the invention should not be viewed as limited except by the scope and spirit of the appended claims.

### Glossary Of Foreign Exchange Terms

AMERICAN-STYLE OPTION: An option which may be exercised at any time between the transaction and expiration date.

AT-THE-MONEY OPTION: For options, an at-the-money option is one whose strike price is the same as the current (spot or forward) rate.

BEGIN DATE: The first date of the “window” period of the variable date forward contract on which a seller may deliver all or a portion (or buyer may take delivery), of the designated currency to the service provider as directed and receive (or pay) the US dollar equivalent based on the contract exchange rate

BUYER/HOLDER: For options, the party who obtains the rights of the option by a premium.

CALL OPTION: An option that grants the holder the right, but not the obligation, to buy the currency.

CASH SETTLEMENT: The closing of an instrument by marking it to market and settling the outstanding obligation in

USD (assuming a US base currency) instead of delivering the underlying currency.

COUNTERPARTY: Each trade has a counterparty—it is the institution with which the trade is booked.

DERIVATIVES: An instrument whose value is derived from the value of an underlying asset. Currency derivatives include: forwards, options, and swaps.

END DATE: The last day of the “window” period of the variable date forward contract on which a seller may deliver all or the final portion (or buyer must take delivery), of the designed currency according to the service provider's instructions and receive (or pay) the US dollar equivalent based on the contract exchange rate.

EXPIRATION DATE: For Participating Forwards, the date on which the Participating Exchange Rate is established, generally two business days prior to the Settlement Date on a Participating Forward Contract. For Options, the last date on which the holder of the option may exercise the option contract.

EUROPEAN-STYLE OPTION: An option which may be exercised only on the expiration date.

FORWARD CONTRACT: For a seller of currency, a contract providing the seller of a foreign currency with a firm exchange rate for the conversion of a designated amount of currency on a specific date in the future. This is the most common vehicle used to hedge transactions because forwards are available in most convertible currencies, for small and large amounts, and for various dates in the future. (For buyers of currency, reverse the position.)

FORWARD RATE: The exchange rate for sale (or purchase) of a designated amount of foreign currency into base currency at a future date. It represents the difference in interest rates between the base and foreign currency's countries and is quoted as “points” from the current spot rate. There are many types of forward rates.

HEDGE: To offset an underlying currency position by taking an opposing position at the expense of potential gain or by neutralizing the position through instruments.

IN-THE-MONEY OPTION: For options, an in-the-money option, if exercised immediately would result in a gain for the option holder.

MARK-TO-MARKET: The process of determining the present market value of a derivative or of a position.

MATURITY DATE: When selling foreign currency forward, the date on which the foreign currency must be credited to Service Provider's designated account and the day on the Service Provided will credit its customer with the base currency equivalent. When buying foreign currency forward, the date on which the Service Provider must deliver the foreign currency as directed by its customer and the date on which the Service Provider will then debit its customer's account for the base currency equivalent.

NON-DELIVERABLE FORWARD: A forward contract which may be settled only in the base currency based on the net base currency settlement amount, so no foreign currency transfer is made

OUT-OF-THE-MONEY OPTION: For options, an out-of-the-money-option, if exercised immediately would result in a loss for the option holder

PREMIUM: The nonrefundable purchase price of the Option Contract which is paid up front by the Company purchasing the contract to the service provider.

PUT OPTION: A contract providing the right, but not the obligation, to sell a designated amount of foreign currency at an agreed upon exchange rate, for a specific date or time period. Option provide the opportunity to benefit from a favorable exchange rate movement while having protection from an adverse move. In return for the flexibility, an up front Premium is paid. The buyer/holder of the option is the party who obtains the rights of the option by paying the premium while the option seller/writer is the party granting the rights of the option in return for receipt of the premium.

SETTLEMENT DATE: The date on which the foreign currency must be credited/debited to the Service Provider's account and the date on which the Service Provider debits/credits the customer with the base currency equivalent.

SPOT CONTRACT: A contract providing the seller (or buyer) of a foreign currency with a firm exchange rate for the conversion of a designated amount of that currency, generally for delivery in two business days, but with some exceptions, including for delivery the following business day. This gives a company knowledge in advance what the exchange rate is on a conversion, and consequently, the US dollar equivalent.

SELLER/WRITER: For options, the party who grants the rights of the option in return for receipt of the premium.

STRIKE PRICE: The agreed upon exchange rate at which the foreign currency may be bought or sold. This rate is chosen by the buyer/holder of the option. It may be: At-the-Money, the strike price equal to the current forward rate for the underlying currency; in-the-money, if exercised immediately it would result in a gain for the option holder; or out-of-the-money, if a loss would immediately result should the option be exercised.

SWAP CONTRACT: Contracts to purchase (or sell) currency for delivery on one date and simultaneously to sell (or purchase) the same currency for a particular date in the future at a given price, the swap price.

TRANSACTION EXPOSURE: When a transaction is booked and requires conversion, the cash flow differential created by exchange rate changes between the time it is book and the time is it settled is termed transaction exposure.

VALUE AT RISK: Methodology for determining current market value of a derivative that factors multiple variables including the current market rate, credit risk, and volatility.

VALUE DATE (OR MATURITY DATE): If a sale contract, the date on which the foreign currency must be credited to the foreign exchange service provider's account as instructed and the day on which the provider credits the company's account with the US dollar equivalent.

VARIABLE DATE FORWARD CONTRACT: A contract providing the seller (or buyer) of a foreign currency with a firm exchange rate for the conversion of a designated amount of that currency during a specified time period (or “window”) which may be up to 30 days long and up to 12 months in the future. This contract is useful when an obligation to convert is firm, but the exact date of which payment will be received (or made) is uncertain.

VOLATILITY: Measurement of risk based on anticipated future movement rather than based on historical movements.

What is claimed is:

1. A method, operable in a server system, for providing foreign exchange risk-related services, comprising:
obtaining a currency exchange risk exposure; and
determining an appropriate hedge alternative consistent with said currency exchange risk exposure.

2. The method of claim 1, wherein said obtaining said currency exchange risk exposure further comprises receiving indication of said currency exchange risk exposure from a user.

3. The method of claim 1, wherein said obtaining said currency exchange risk exposure further comprises:
presenting at least one on-line survey question; and
receiving, in response to said at least one on-line survey question, at least one user-provided answer, said answer including indication of said currency exchange risk exposure.

4. The method of claim 3, wherein said at least one on-line survey question includes an inquiry regarding countries to which said user exports.

5. The method of claim 3, wherein said at least one on-line survey question includes an inquiry regarding countries from which said user imports.

6. The method of claim 3, wherein said at least one on-line survey question includes an inquiry regarding countries in which competitors exist for said user.

7. The method of claim 3, further comprising:
displaying, in response to said at least one user-provided answer, at least one exposure map, wherein said exposure map graphically illustrates said at least one user-provided answer.

8. The method of claim 3, further comprising:
displaying, in response to said at least one user-provided answer, a series of exposure maps, wherein each one of said exposure maps in said series of exposure maps illustrates at least a corresponding one of said at least one user-provided answer.

9. The method of claim 3, wherein said at least one on-line survey question further comprises presenting a best practices survey.

10. The method of claim 3, wherein said presenting said best practices survey further comprises:
comparing said at least one user-provided answer with at least one predetermined answer;
in the event that said at least one user-provided answer matches said at least one predetermined answer, selecting a current user as one of a group of benchmark respondents.

11. The method of claim 10, further comprising:
recording a plurality of answers provided by said group of benchmark respondents; and
displaying data derived from said plurality of answers provided by said group of benchmark respondents in response to other users completing an on-line survey including said at least one on-line survey question.

12. A method, operable in a server system, for focusing currency exchange market data onto a user's currency exchange exposure, comprising:
obtaining said user's currency exchange exposure;
obtaining said currency exchange market data; and
providing at least one display object, responsive to said user's currency exchange exposure and said currency exchange market data, wherein said at least one display object displays at least one currency exchange rate for at least one currency indicated by said user's currency exchange exposure.

13. The method of claim 12, wherein said providing said at least one display object further comprises displaying said at least one currency exchange rate based on a historical exchange rate for said at least one currency indicated by said user's currency exchange exposure.

14. The method of claim 12, wherein said providing said at least one display object further comprises displaying said at least one currency exchange rate based on a current exchange rate for said at least one currency indicated by said user's currency exchange exposure.

15. The method of claim 12, wherein said providing said at least one display object further comprises displaying said at least one currency exchange rate based on a current exchange rate for said at least one currency indicated by at least one past currency transaction associated with said user.

16. The method of claim 12, wherein said providing said at least one display object further comprises displaying a benchmark currency exchange rate.

17. The method of claim 12, wherein said providing at said least one display object further comprises displaying said at least one forecast currency exchange rate based on a current exchange rate for said at least one currency indicated by at least one past currency transaction associated with said user.

18. The method of claim 12, further comprising generating said at least one forecast currency exchange rate in response to at least one user-provided exchange rate.

19. The method of claim 12, wherein said at least one user-provided exchange rate reflects at least one currency exposure associated with said user.

20. The method of claim 12, wherein said providing at said least one display object further comprises displaying at least one currency exchange price associated with at least one hedge instrument.

21. A method, operable in a server system, of ensuring banking compliance standards are met, comprising:
monitoring user actions with respect to activities regarding mitigating foreign currency risk exposure; and
providing, responsive to said monitoring of said user actions, at least one on-line workshop in the event that said user actions include at least one predetermined user action, wherein said at least one on-line workshop presents data regarding foreign currency risk management related to said at least one predetermined user action.

22. The method of claim 21, wherein said at least one predetermined user action comprises requesting a hedge transaction.

23. The method of claim 21, further comprising:
wherein said providing said at least one on-line workshop includes providing an on-line test; and
blocking said request for said hedge transaction in the event that said user fails said on-line test.

24. The method of claim 21, wherein said providing said at least one on-line workshop further comprises:
providing course content reflecting predetermined user-specific profile information.

25. The method of claim 24, wherein said content reflecting said predetermined user-specific profile information comprises at least one user selected base currency and at least one user selected foreign currency.

26. The method of claim 25, wherein said content reflecting said predetermined user-specific profile information further comprises at least one user defined business exposure relating to said at least one user selected base currency and said at least one user selected foreign currency.

27. The method of claim 26, wherein said at least one business exposure comprises an import.

28. The method of claim 26, wherein said at least one business exposure comprises an export.

29. A method, operable in a server system, of determining a foreign currency risk management policy, comprising:
providing at least one policy development question;
obtaining, in response to said at least one policy development question, at least one user-provided answer;
storing said at least one user-provided answer into a foreign currency risk management policy template;
monitoring activities of a user; and
preventing at least one predetermined activity of said user in the event that said user activity conflicts with said risk management policy template.

30. The method of claim 29, wherein said at least one policy development question includes an inquiry regarding degrees of risk that are acceptable to a user.

31. The method of claim 29, wherein said at least one policy development question includes an inquiry regarding measurement of a type of foreign currency risk.

32. The method of claim 31, wherein said type of foreign currency risk comprises transaction risk.

33. The method of claim 29, wherein said at least one predetermined activity of said user comprises requesting a hedge transaction.

34. A method, operable in a server system, for estimating at least one corresponding price, said corresponding price responsive to an original price, wherein said corresponding price reflects foreign currency exchange rate fluctuation, comprising:
obtaining a base currency;
obtaining said original price in said base currency;
obtaining a foreign currency;
obtaining at least one analysis period;
obtaining exchange rates between said base currency and said foreign currency relative to said at least one analysis period; and
calculating said corresponding price responsive to said original price, said analysis period, and said exchange rates.

35. The method of claim 34, wherein said analysis period comprises a range between a start date and an end date.

36. The method of claim 34, wherein said analysis period is a point in time in the future.

37. The method of claim 34, further comprising obtaining a volatility of said exchange rates.

38. The method of claim 37, wherein said volatility reflects a probability that said exchange rates change during said analysis period, and a predicted degree of said change.

39. The method of claim 34, further comprising, responsive to a user request, saving said display of said first foreign currency exchange rate attribute and said second foreign currency exchange rate attribute over said analysis period.

40. The method of claim 34, further comprising, responsive to a user request, reformulating said display of said first foreign currency exchange rate attribute and said second foreign currency exchange rate attribute over said analysis period.

41. The method of claim 34, further comprising, responsive to a user request, sending said display of said first foreign currency exchange rate attribute and said second foreign currency exchange rate attribute over said analysis period to at least one other user.

42. The method of claim 34, further comprising, responsive to a user request, displaying information describing a process for applying said display of said first foreign currency exchange rate attribute and said second foreign currency exchange rate attribute over said analysis period to a user specific problem.

43. A method, operable in a server system, for comparing a first foreign currency exchange rate attribute and a second foreign currency exchange rate attribute relative to a target currency, wherein said first foreign currency exchange rate attribute is responsive to a first base currency, and wherein said second foreign currency exchange rate attribute is responsive to a second base currency:
obtaining said first base currency;
obtaining said second base currency;
obtaining said target currency;
obtaining at least one analysis period;
obtaining said first foreign currency exchange rate attribute and said second foreign currency exchange rate attribute relative to said at least one analysis period; and
simultaneously displaying said first foreign currency exchange rate attribute and said second foreign currency exchange rate attribute over at least a portion of said analysis period.

44. The method of claim 43, further comprising:
presenting a plurality of relevant measures of economic performance;
obtaining a user selection of one of said plurality of relevant measures of economic performance; and
presenting, simultaneously with said displaying of said first foreign currency exchange rate attribute and said second foreign currency exchange rate attribute, in graphical format, said selected one of said plurality of relevant measures of economic performance over said analysis period.

45. The method of claim 43, wherein said first foreign currency exchange rate attribute and said second foreign currency exchange rate attribute represent exchange rates.

46. The method of claim 43, wherein said first foreign currency exchange rate attribute and said second foreign currency exchange rate attribute represent volatility.

47. The method of claim 43, further comprising, responsive to a user request, saving said display of said first foreign currency exchange rate attribute and said second foreign currency exchange rate attribute over said analysis period.

48. The method of claim 43, further comprising, responsive to a user request, reformulating said display of said first foreign currency exchange rate attribute and said second foreign currency exchange rate attribute over said analysis period.

49. The method of claim 43, further comprising, responsive to a user request, sending said display of said first foreign currency exchange rate attribute and said second foreign currency exchange rate attribute over said analysis period to at least one other user.

50. The method of claim 43, further comprising, responsive to a user request, displaying information describing a process for applying said display of said first foreign currency exchange rate attribute and said second foreign currency exchange rate attribute over said analysis period to a user specific problem.

51. A method, operable in a server system, of determining at least one foreign currency price, comprising:
obtaining at least one user problem specific variable;
obtaining relevant market data;
displaying a plurality of costs associated with corresponding hedge strategies;
obtaining a user selection of at least one of said hedge strategies; and
calculating and displaying at least one price associated with said user selected hedge strategy.

52. The method of claim 51, further comprising:
obtaining a user selection of a second one of said hedge strategies; and
calculating and simultaneously displaying at least one price associated with said selected second one of said hedge strategies.

53. The method of claim 51, further comprising displaying a variance between said price associated with said selected first one of said hedge strategies and said price associated with said selected second one of said hedge strategies.

54. The method of claim 51, further comprising, responsive to a user request, saving said display of said at least one price associated with said user selected hedge strategy.

55. The method of claim 51, further comprising, responsive to a user request, reformulating said display of said at least one price associated with said user selected hedge strategy.

56. The method of claim 51, further comprising, responsive to a user request, sending said display of said at least one price associated with said user selected hedge strategy.

57. The method of claim 51, further comprising, responsive to a user request, displaying information describing a process for applying said display of said at least one price associated with said user selected hedge strategy.

58. A method, operable in a server system, for determining exposure foreign currency rate fluctuation, comprising:
obtaining user profile information describing business activities in a foreign country;
presenting a plurality of hedge strategies;
obtaining a user selection of one of said plurality of hedge strategies;
obtaining market data relevant to said selected one of said plurality of hedge strategies; and
calculating and displaying, responsive to said user selected one of said plurality of hedge strategies, forecasted currency values related to said business activities in said foreign country.

59. The method of claim 58, further comprising:
displaying a plurality of hedge instruments associated with said selected one of said plurality of hedge strategies;
obtaining a user selection of one of said plurality of hedge instruments; and
issuing a request for a purchase of said selected one of said plurality of hedge instruments.

60. The method of claim 58, wherein obtaining said user profile information describing business activities in a foreign country includes loading a user profile, said user profile including a value of said business activities in said foreign country.

61. The method of claim 58, wherein said obtaining said user profile information describing business activities in a foreign country further comprises obtaining authorization that a current user is permitted to provide said profile information.

62. The method of claim 58, further comprising calculating and displaying an aggregate exposure to foreign currency exchange rates resulting from said business activities.

63. The method of claim 62, wherein said calculating of said aggregate exposure is responsive to at least one forecast of at least one currency exchange rate.

64. The method of claim 62, wherein said calculating of said aggregate exposure is responsive to a user selected hedge strategy.

65. A method, operable in a server system, for displaying an exposure to foreign currency exchange rate fluctuation, comprising:
displaying a current open position with regard to exposure to foreign currency exchange rate fluctuation;
obtaining at least one exchange rate; and
responsive to said obtained exchange rate, displaying a transaction display object reflecting said obtained exchange rate.

66. A method, operable in a server system, for displaying an exposure to foreign currency exchange rate fluctuation, comprising:
displaying a current open position with regard to exposure to foreign currency exchange rate fluctuation;
obtaining at least one exchange rate;
obtaining a user selection of said at least one exchange rate; and
responsive to said obtained exchange rate and said user selection of said obtained exchange rate, establishing said obtained exchange rate as a benchmark rate.

67. A method, operable in a server system, for analyzing at least one hedge strategy, comprising:
displaying a plurality of decision categories;
obtaining a user selection of one of said decision categories;
displaying, responsive to said selected one of said decision categories, a predetermined analysis model corresponding to said selected one of said decision categories; and
applying said corresponding analysis model to user data.

68. The method of claim 67, wherein said plurality of decision categories are oriented towards a predetermined target user market.

69. The method of claim 68, wherein said target user market is small to medium sized businesses.

70. The method of claim 67, further comprising:
wherein said displaying of said model comprises displaying data associated with at least one hedge strategy and at least one economic scenario.

71. The method of claim 70, further comprising:
displaying, in graphical format, at least one outcome of said at least one economic scenario applied to said at least one hedge strategy.

72. The method of claim 71, wherein said displaying of said at least one outcome includes indication of a time period during which said at least one hedge strategy applies.

73. The method of claim 71, wherein said displaying of said at least one outcome includes a display of at least one calculation on which said is based.

74. The method of claim 73, wherein said displaying of said analysis model further comprises displaying of at least one predetermined component of said corresponding decision category.

75. The method of claim 74, wherein said at least one predetermined component of said corresponding decision category relates to a predetermined user market.

76. The method of claim 75, wherein said predetermined user market is small to medium scale businesses.

77. The method of claim 76, further comprising displaying a process description, wherein said process description describes a sequence of user activities required to implement one of a plurality of hedge strategy alternatives.

78. The method of claim 76, further comprising displaying a theory description, wherein said theory description describes a basis for user selection of one of a plurality of hedge strategy alternatives.

79. A method, operable in a server system, of populating a transaction request interface, wherein said transaction request interface includes a currency transaction entry screen, comprising:
obtaining a plurality of user exposures to foreign currency exchange rate fluctuation;
aggregating said plurality of user exposures into an aggregate exposure; and
passing said aggregate exposure to said transaction request interface, such that said transaction request interface represents a transaction amount equal to said aggregate exposure.

80. A method, operable in a server system, for presenting a summary position report regarding exposure to currency exchange rate fluctuation, comprising:
obtaining an overall exposure level associated with a user;
displaying, by currency, a currency risk based on said overall exposure level;
displaying, by currency and simultaneous with said displaying of said overall exposure level, a counterparty risk based on said currency risk; and
displaying, by country and simultaneous with said displaying of said overall exposure level and said counterparty risk, a country risk based on said currency risk.

81. A method, operable in a server system, of supporting compliance with at least one banking standard, comprising:
monitoring activities of a user;
obtaining at least one set of compliance criteria;
responsive to detection of at least one predetermined user activity, applying at least one of said compliance criteria said detected activity and an identity of a current user; and
deny a request associated with said detected user activity in the event that said at least one of said compliance criteria is not satisfied with regard to said detected activity and said identity of said current user.

82. The method of claim 81, wherein said detected activity comprises a request for a transaction regarding a currency hedge.

83. The method of claim 81, further comprising:
obtaining said compliance criteria from a service provider.

84. The method of claim 81, further comprising:
obtaining said compliance criteria from a business organization associated with said current user.

85. The method of claim 81, further comprising:
requiring online training associated with said detected user activity in the event that said at least one of said compliance criteria is not satisfied with regard to said detected activity and said identity of said current user.

86. The method of claim 81, further comprising:
indicating a detected deficiency in the event that said at least one of said compliance criteria is not satisfied with regard to said detected activity and said identity of said current user.

87. The method of claim 81, wherein said applying said at least one of said compliance criteria is further responsive to a history of previous user activities.

88. A method, operable in a server system, for identifying business opportunities, comprising:
maintaining a database of information regarding foreign currency exchange rate risk exposure;
identifying, within said database, information relevant to business opportunities outside the area of foreign currency exchange; and
determining at least one business opportunity relevant outside the area of foreign currency exchange; and
generating a message identifying said determined opportunity outside the area of foreign currency exchange.

89. A system for providing foreign currency exchange risk advisory services via a server system, wherein said server system includes at least one processor, a program storage memory, and program code stored within said program storage memory, wherein said program code comprises:
a knowledge engine, wherein said knowledge engine includes software components operable to obtain market knowledge, formulate foreign currency exchange rate risk policies, and to provide online training with regard to foreign currency exchange rate risk management;
decision support technology, wherein said decision support technology includes software components operable to formulate foreign currency exchange rate risk policies, determine at least one foreign currency price, measure at least one foreign currency exposure, and to analyze at least one hedge strategy; and
a transactional interface, wherein said transactional interface includes software components operable to implement said at least one hedge strategy, and to report said implementing of said at least one hedge strategy.

90. A server system connectable to a computer network, operable to provide foreign exchange risk-related services, comprising:
program code for obtaining a currency exchange risk exposure; and
program code for determining an appropriate hedge alternative consistent with said currency exchange risk exposure.

91. A server system connectable to a computer network, operable to focus currency exchange market data onto a user's currency exchange exposure, comprising:
program code for obtaining said user's currency exchange exposure;
program code for obtaining said currency exchange market data; and
program code for providing at least one display object, responsive to said user's currency exchange exposure and said currency exchange market data, wherein said at least one display object displays at least one currency exchange rate for at least one currency indicated by said user's currency exchange exposure.

92. A server system, connectable to a computer network, operable to ensure banking compliance standards are met, comprising:
program code for monitoring user actions with respect to activities regarding mitigating foreign currency risk exposure; and
program code for providing, responsive to said monitoring of said user actions, at least one on-line workshop in the event that said user actions include at least one predetermined user action, wherein said at least one on-line workshop presents data regarding foreign currency risk management related to said at least one predetermined user action.

93. A server system, connectable to a computer network, operable to determine a foreign currency risk management policy, comprising:
program code for providing at least one policy development question;
program code for obtaining, in response to said at least one policy development question, at least one user-provided answer;
program code for storing said at least one user-provided answer into a foreign currency risk management policy template;
program code for monitoring activities of a user; and
program code for preventing at least one predetermined activity of said user in the event that said user activity conflicts with said risk management policy template.

94. A server system, connectable to a computer network, operable to estimate at least one corresponding price, said corresponding price responsive to an original price, wherein said corresponding price reflects foreign currency exchange rate fluctuation, comprising:
program code for obtaining a base currency;
program code for obtaining said original price in said base currency;
program code for obtaining a foreign currency;
program code for obtaining at least one analysis period;
program code for obtaining exchange rates between said base currency and said foreign currency relative to said at least one analysis period; and
program code for calculating said corresponding price responsive to said original price, said analysis period, and said exchange rates.

95. A server system, connectable to a computer network, operable to compare a first foreign currency exchange rate attribute and a second foreign currency exchange rate attribute relative to a target currency, wherein said first foreign currency exchange rate attribute is responsive to a first base currency, and wherein said second foreign currency exchange rate attribute is responsive to a second base currency:
obtaining said first base currency;
obtaining said second base currency;
obtaining said target currency;
obtaining at least one analysis period;
obtaining said first foreign currency exchange rate attribute and said second foreign currency exchange rate attribute relative to said at least one analysis period; and
simultaneously displaying said first foreign currency exchange rate attribute and said second foreign currency exchange rate attribute over at least a portion of said analysis period.

96. A server system, connectable to a computer network, operable to determine at least one foreign currency price, comprising:
program code for obtaining at least one user problem specific variable;
program code for obtaining relevant market data;
program code for displaying a plurality of costs associated with corresponding hedge strategies;
program code for obtaining a user selection of at least one of said hedge strategies; and
program code for calculating and displaying at least one price associated with said user selected hedge strategy.

97. A server system, connectable to a computer network, operable to determine exposure foreign currency rate fluctuation, comprising:
program code for obtaining user profile information describing business activities in a foreign country;
program code for presenting a plurality of hedge strategies;
program code for obtaining a user selection of one of said plurality of hedge strategies;
program code for obtaining market data relevant to said selected one of said plurality of hedge strategies; and
program code for calculating and displaying, responsive to said user selected one of said plurality of hedge strategies, forecasted currency values related to said business activities in said foreign country.

98. A server system, connectable to a computer network, operable to display an exposure to foreign currency exchange rate fluctuation, comprising:
program code for displaying a current open position with regard to exposure to foreign currency exchange rate fluctuation;
program code for obtaining at least one exchange rate; and
program code, responsive to said obtained exchange rate, for displaying a transaction display object reflecting said obtained exchange rate.

99. A server system, connectable to a computer network, operable to display an exposure to foreign currency exchange rate fluctuation, comprising:
program code for displaying a current open position with regard to exposure to foreign currency exchange rate fluctuation;
program code for obtaining at least one exchange rate;
program code for obtaining a user selection of said at least one exchange rate; and
program code, responsive to said obtained exchange rate and said user selection of said obtained exchange rate, for establishing said obtained exchange rate as a benchmark rate.

100. A server system, connectable to a computer network, operable to analyze at least one hedge strategy, comprising:
program code for displaying a plurality of decision categories;
program code for obtaining a user selection of one of said decision categories;
program code for displaying, responsive to said selected one of said decision categories, a predetermined analysis model corresponding to said selected one of said decision categories; and
program code applying said corresponding analysis model to user data.

101. A server system, connectable to a computer network, operable to populate a transaction request interface, wherein said transaction request interface includes a currency transaction entry screen, comprising:
program code for obtaining a plurality of user exposures to foreign currency exchange rate fluctuation;
program code for aggregating said plurality of user exposures into an aggregate exposure; and
program code for passing said aggregate exposure to said transaction request interface, such that said transaction request interface represents a transaction amount equal to said aggregate exposure.

102. A server system, connectable to a computer network, operable to present a summary position report regarding exposure to currency exchange rate fluctuation, comprising:
obtaining an overall exposure level associated with a user;
displaying, by currency, a currency risk based on said overall exposure level;
displaying, by currency and simultaneous with said displaying of said overall exposure level, a counterparty risk based on said currency risk; and
displaying, by country and simultaneous with said displaying of said overall exposure level and said counterparty risk, a country risk based on said currency risk.

103. A server system, connectable to a computer network, operable to support compliance with at least one banking standard, comprising:
monitoring activities of a user;
obtaining at least one set of compliance criteria;
responsive to detection of at least one predetermined user activity, applying at least one of said compliance criteria said detected activity and an identity of a current user; and
deny a request associated with said detected user activity in the event that said at least one of said compliance criteria is not satisfied with regard to said detected activity and said identity of said current user.

104. A server system, connectable to a computer network, operable to identify business opportunities, comprising:
maintaining a database of information regarding foreign currency exchange rate risk exposure;
identifying, within said database, information relevant to business opportunities outside the area of foreign currency exchange; and
determining at least one business opportunity relevant outside the area of foreign currency exchange; and
generating a message identifying said determined opportunity outside the area of foreign currency exchange.
